(19) United States
(12) Patent Application Publication
(10) Pub. No.: US 2017/0102925 A1
(43) Pub. Date: Apr. 13, 2017

(54) AUTOMATCH PROCESS AND SYSTEM FOR SOFTWARE DEVELOPMENT KIT FOR APPLICATION PROGRAMMING INTERFACE

(71) Applicants: Syed Adeel ALI, Auckland (NZ); Zeeshan BHATTI, Auckland (NZ); Parthasarathi ROOP, Auckland (NZ); APIMatic Limited, Auckland (NZ)

(72) Inventors: Syed Adeel Ali, Auckland (NZ); Zeeshan Bhatti, Auckland (NZ); Parthasarathi Roop, Auckland (NZ)

(21) Appl. No.: 15/129,085

(22) PCT Filed: Mar. 26, 2015
(86) PCT No.: PCT/NZ2015/000019

§ 371 Date: Sep. 26, 2016

Related U.S. Application Data
(60) Provisional application No. 62/093,249, filed on Dec. 17, 2014.

(30) Foreign Application Priority Data
Mar. 26, 2014 (AU) 2014901079
Apr. 17, 2014 (AU) 2014901415
May 26, 2014 (AU) 2014901974
May 26, 2014 (AU) 2014901979

(51) Int. Cl. G06F 9/44

(52) U.S. Cl. CPC G06F 8/36

(57) ABSTRACT

A computer system and process is provided to generate computer programming code, such as in a Software Development Kit (SDK). The SDK generated allows an application to use a given API. An API description interface of the system is operable to receive API-description code describing one or more endpoints of the API. A template interface is operable to receive one or more templates of code defining classes and/or functions in a programming language which can be selected by the selection of a set of templates. A data store is operable to use a defined data structure to store records of API description code to provide a structured stored description of the API. A code generation module is operable to combine records of API with templates of code which are arranged in sets by the language of the code they contain. The combining of records and code from templates may use pointers to a data structure which is common to corresponding templates in different sets to allow templates of selected languages to be combined with any API description stored.

### FIELD OF THE INVENTION

The present invention relates to a computer implemented process and system for the generation of programming kits of code for use in the development of applications which interact with Application Programming Interfaces (APIs) of other software systems, such as processes and systems for the provision of Software Development Kits (SDKs).

### BACKGROUND OF THE INVENTION

Internet browsers, smart phone applications and applications running on other computers (APPs) provide convenient user interfaces to larger software systems that may store and manage user data and content for example.

AAPIs provide an interface for software systems and are often referred to as providing a service, such as a web or cloud service for example.

Documentation describing API are made available to developers of applications or APPS that are able to interface with the API to use the service they represent. API documentation is typically a file carrying a description of the API. Typically an API description has elements of code which collectively describe the API and its functionality, such as endpoints and parameters used in requests and responses involving the endpoints. The API description is typically expressed in a mark-up language. An API description may also include help files and documentation.

A developer of an app includes code, in a programming language, which interfaces with an API as it is described in an API description.

A challenge in the use of APIs arises when they are updated, which can be frequently. This generally requires the programming code of APPs which use the service to be updated.

Challenges also arise through applications often needing to be developed in a variety of programming languages for use with a variety of platforms, such as Android™, iOS™, or Windows™.

Challenges also arise through applications being developed by a population of developers with varying levels of knowledge of API's and mark-up languages that may be used to describe them.

Challenges also arise by applications being developed by a population of developers with varying approaches to the development of programming code for applications.

These issues are relevant to mobile devices, desk-top computers, computers and a variety of applications, APPs and computer programs using cloud services, business-to-business interfaces, interfaces for software services internally within an enterprise, interfaces over the internet, and user access via web browsers.

The reference to any prior art in the specification is not, and should not be taken as, an acknowledgement or any form of suggestion that the prior art forms part of the common general knowledge in any country.

### SUMMARY OF THE INVENTION

It is an object of an embodiment of the invention to provide a system or method for generating programming code which will overcome or ameliorate problems with such at present, at least provide the public with the useful choice.

It is an object of an embodiment of the invention to provide a system or method for generating software development kits which will overcome or ameliorate problems with such at present, at least provide the public with the useful choice.

Other objects of the present invention may become apparent from the following description, which is given by way of example only.

API: As used herein an API is an application program interface that provides programmatic access to a software system, and includes web APIs for applications hosted on the internet.

API description: As used herein an API description is data, text or code which describes an API and how an application can interface with the API, and which includes but is not limited to defining names and addresses of one or more endpoints of an API and endpoint parameters for inputs to the endpoints and outputs from the endpoints.

Format: As used herein, format refers to a formal structure of an API description document.

Endpoint parameters: As used herein, endpoint parameters define incoming (request) data structures and outgoing (response) data structures associated with respective endpoints.

API wrapper Code: As used herein, API wrapper code is program code in a programming language dependent on functionality of an API represents the functionality of an API wrapped up in a programming language. It is also known as API access code sometimes as it accesses the API.

SDK: As used herein, SDK stands for Software Development Kit and refers to a kit of program code in a programming language which defines functionality for interacting with an API, and includes but is not limited to API wrapper code.

SDL: As used herein, SDL, or Service Description Language, is a data-model representing one or more API descriptions supported by the present system whereby an API can be described using instantiation of the SDL, wherein the term includes but is not limited to data structures and databases.

Data Structure: As used herein a data structure is a way of organising data that can be instantiated to store records, code, data or units of metadata, and can be instantiated using any means of storage including memory, objects and databases.

API Record: As used herein, API record refers to information of a selected API stored in instances of data structure.

Widget: As used herein, a widget, also referred to as a web widget, is an application that can be embedded and executed within a web page, or similar document, by an end user to perform a function using data or code fetched from other web resources.

Data model: In this document data model refers to a model used to structure data describing APIs.

Aspects of the present invention comprise a computer implemented process for generating programming code from templates with API records stored using a data structure which corresponds to pointers included in the templates, wherein the templates are arranged in template sets such that two or more sets include two or more templates having pointers to the data structure in common wherein each set corresponds to a programming language to allow a selection of programming languages for code combined with any API selected and stored using the data structure.

One aspect of the present invention provides a computer implemented process for generating program code in a selected programming language wherein the code is operable to interact with an API, the process comprising the steps of:

receiving API description code describing the API;
storing the API description in an instance of a data structure to provide stored API records describing the API, wherein the data structure is capable of describing any of a set of supported APIs from which the API may be selected;
loading one or more templates of program code from a stored set of templates, wherein a set comprises code in a programming language selected from a set of supported programming languages and wherein selection of a template set determines the programming language of generated code;
retrieving API records and combining them with code provided by retrieved templates of a selected template set to generate program code in the programming language of the template set.

The process may comprise generating a user interface operable to receive inputs identifying, describing or selecting an API or a file describing the API.

The process may comprise retrieving a template dependent on data received which defines a selection of a programming language.

The process may comprise generating a user interface operable to receive inputs identifying, describing or selecting a template set or programming language.

The data structure may be common to each template.

The data structure may be common to each API supported.

The process may be performed by a software system which provides an API which is operable to receive descriptions of APIs and to provide generated SDKs.

Combining the templates with API records may comprise filling in the template with the API records. This may comprise filling in spaces defined in the template for API records.

Individual templates may be selected dependent on the data structure or specific records in an instance of the data structure to allow a collection of template-sets to be used to generate code for any of the selected supported APIs stored according to the data structure.

The API records stored using the storage structure may be associated with templates by the storage structure.

The API description may include a description of endpoints of the API and input and output parameters associated with the endpoints.

The templates may comprise code defining methods and/or classes and/or functions in the programming language.

The templates may comprise code defining compiler files and/or configuration files and/or scripts and/or addresses for components of applications.

The templates may be selected from the template-set dependent on the structure used to store API records. The templates may define classes and/or functions each corresponding to types of API records identified by the API structure. The structure may be a data structure. The structure may be a data model used to define types of records and storage and access to the records.

Aspects of the present invention provide a system for generating program code in a selected programming language to interact with an API, the system comprising:

a structured storage for API records which describe an API, the storage structured so as to be capable of describing one or more supported APIs from which the given API may be selected;
two or more stored template-sets each set comprising templates of program code to be filled in with relevant API description to generate code, wherein the templates of each template-set comprises code in a common programming language selected from a set of supported programming languages;
an API interface operable to receive API description code describing endpoints of the API and describing input and output parameters associated with the endpoints to describe conditions for interaction with the API, the API interface operable to populate records of the structured storage to provide a stored description of the API;
a language selection interface operable to receive inputs to identify a selection of a supported programming language; and
a kit generation engine operable to generate code dependent on the template-sets and dependent on the API description code received.

The code may be generated dependent also on a selection of an API made from the one or more selected APIs.

The API description code may be received in a file containing a structured API description.

Alternatively the API description code may be received as inputs at a user interface to allow a user to describe an API. This may allow a user to define an API description for the system or to use the system from an informal API description.

A kit may comprise a collection of classes or types in a programming language, wherein the classes or types define functionality to interact with an API.

A kit may comprise compiler files to allow the classes to be compiled.

A kit may provide API access code or API interface code for a program or web application or a mobile application.

A template may comprise stored programming code.

A template may comprise spaces for API records.

A template may comprise static code which gets converted to the kit code as is.

A template may comprise dynamic code which gets replaced by a respective API record.

A kit may be a Software development Kit (SDK). The SDK may be specific to a given or selected integrated development environment.

The kit generation engine may be operable to instantiate the API records into memory.

The kit generation engine may be operable to associate API records with templates selected from a selected template-set.

The kit generation engine may be operable to generate program code by combining API records with code stored in a template associated with the record. Combining may be inserting in spaces.

The system may comprise an API description database operable to store API descriptions expressed using the data model.

The system may store a collection set of API descriptions for selection and retrieval for use by the kit generation engine. The system may store a set of keys to identify a stored API description for use by the kit generation engine, whereby the key can reference an API description of a selected supported API.

The system may comprise a search module operable to search for API descriptions. This may be directed by inputs at a user interface.

The system may comprise a crawler operable to find API descriptions in the database and/or on the internet.

The structured storage may be a remote server or a local server.

The template-sets may be provided by a remote server or a local server.

Another aspect of the present invention comprises a widget capable of being embedded within a document, the widget comprising an API identifier to identify an API description stored in an API description data store and comprises a template-set identifier to identify a selection of a set of one or more templates to be used to generate code from the API description.

A document may be a web page or a web site or a HTML file.

The template-set identifier may be a programming language identifier which identifies a selection of programming language used for a template-set.

The widget may comprise request code operable when run to send a request to a code-generation server the request containing the API identifier and template-set.

The widget may comprise user interface code operable when run to present a user interface to allow a user to select a template-set identifier.

The request code and/or user interface code may comprise code which invokes JavaScript code.

Another aspect of the present invention comprises a process for a server to generate API access code for interacting with an API, the process comprising the steps of:

receiving a request comprising an API identifier and a template identifier, retrieving a stored API description code where the retrieval is dependent on the API identifier;
retrieving a template-set comprising one or more templates where the retrieval is dependent on the template identifier generating API interface code dependent on the retrieved template-set.

The process may comprise retrieving a API records collectively describing an API from storage and combining API records with templates selected from the template-set dependent on the position or type of respective records defined by the a structure defined for storage of the retrieved API.

The API identifier may comprise an API key.

The process may comprise sending a response to the request, the response containing the kit and/or a unique identifier to get the kit.

The kit may comprise API access code and/or source code and/or a library and/or header files and/or files to assist code compilation and/or any combination of these.

The API description may comprise code stored as attributes of a data model.

Aspects of the present invention comprise a system for generating kit code comprising one or more components of an interface for a program or application, the system comprising:

an API description database operable to store API descriptions using a defined data model;
a collection of template-sets each corresponding to a software language, each template-set comprising one or more templates for converting an API description to kit code;
a kit generation module operable to generate kit code from a selected API description stored in the API data base using a selected template set.

The system may comprise an interface operable to allow selection of a template-set.

The system may comprise an interface operable to allow selection of a stored API description.

The system may comprise an API storage collection interface operable to store API descriptions in the database.

The system may comprise an API description parser operable to parse API descriptions into the data model defined for the API description database whereby API descriptions in one of multiple supported formats may be converted using parsers respective to API description formats.

Another aspect of the present invention provides a computer system operable to generate programming code for use in developing applications, the programming code operable to allow applications to use an API, the system comprising:

an API description interface operable to receive API-description code describing one or more resources or endpoints of the API;
a template interface operable to receive one or more templates of code defining classes and/or functions in a selected programming language;
a data store operable to store API-description code as records in a defined data structure to provide a structured stored description of the API;
a code generation module operable to select templates from two or more template sets each template set comprising templates having pointers to the data structure in common with a corresponding template in the other set and each set comprising templates of programming code in a different programming language, the code generation module also operable to combine code from templates with stored API description code to generate the code.

The programming code may be native code for functionality of an API.

The data structure is structured dependent on a set of supported APIs.

The data structure is operable to store a superset of metadata carried in API-description code for the set of supported APIs.

The one or more templates may comprise a selected set of templates of code, wherein a set of templates comprises code defining classes and/or functions in a selected programming language.

A set of templates comprises a field for each of the units of metadata supported by the data store, and the code generation module is operable to select templates dependent on units of meta data stored for an API.

According to one aspect, there is provided a computerised method of generating a software developers kit (SDK) for an application programming interface (API), the method comprising: receiving a description of the API in a predetermined format; parsing the API description to generate a generic language data structure (SDL); receiving a user selection of a programming environment (e.g. C#); transforming the data structure into a SDK using templates corresponding to the selected programming environment.

In an embodiment the data structure (SDL) is code generation specific, in other words adapted for use with the programming environment transforming processes. By contrast the incoming API descriptions are not code-generation specific, but carry data in respective pre-determined formats. However whilst the syntax of these different formats may vary, the data itself corresponds to pre-determined elements of an API description, and which include an internet address and request/response parameters information.

In another aspect there is provided a computerised system for generating a software developers kit (SDK) for an application programming interface (API), the system comprising: one or more servers each having memory and a processor and arranged to provide one or more of the following functional modules; an API description interface module for receiving a description of the API in a predetermined format; a parsing module arranged to parse the API description to generate a data structure (SDL) describing the API in a generic language; a plurality of programming environment templates; a user interface module for receiving a user selection of a programming environment; a transformation engine arranged to transform the data structure into an SDK using a said template corresponding to the selected programming environment,

In an embodiment the API description may be received via five different sub-modules: (i) Searching and Selecting the API from an API marketplace/directory/repository and automatically fetching its description, (ii) importing the description document in one of the supported formats, (iii) describing the API by filling in web forms, (iv) receiving API description in a predetermined format as an API request parameter from a third party, (v) Crawling through a list of API repositories/directories one by one, and fetching API descriptions from each of the directories.

For sub-modules (i), (ii), (iv) and (v) the description of the API may be in the form of an API description which is a machine readable file or files usually in a markup language. These are provided by respective API providers. For sub-module (iii), API documentation supplied by an API provider may be used to complete the web forms.

In an embodiment the system is arranged to receive a user selection of a said API description at the user interface module and store a plurality of API descriptions as SDL data structures on the corresponding server.

The embodiment may then generate an SDK in the platform selected by the user using templates respective to the selected platform and the SDL information of the said API.

In an embodiment the API description interface module comprises of a number of webpages for completion of the API description by a user of the interface.

In an embodiment the system provides an API that comprises of a number of endpoints which accepts API description and user selection from a plurality of programming environments.

In an embodiment the SDL data structures are object oriented data structures comprising data entered using the description module.

In an embodiment the SDK is automatically provided to a user in response to selection of the programming environment and one of the pre-described APIs. The SDK may be used to compile an APP for use with the API of a corresponding software package. The APP may be downloaded onto a Smartphone operating according to the selected operating environment.

In an embodiment the programming environments are C#, Java, or iOS.

In a second aspect there is provided a computerised method of generating SDKs for an API of an Internet based service provider, the method comprising: receiving a description of an API using predetermined elements including an Internet address and request parameter; generating API wrapper code dependent on the API description and a programming language selected by a user of the method.

As noted above the description of the API may be received in the form of an API description which is a machine readable file or files usually in a mark-up language. These may be received by selecting an API description from a marketplace/directory/repository, selecting a pre-stored API description from database, importing the API description in one of the supported formats, or receiving an API description together with a request to generate the API wrapper code and a platform selection. Alternatively the description of the API may be received using web forms completed by a user.

API wrapper code is person readable code that can be viewed and modified by a user, for example in an Integrated Development Environment (IDE). The API wrapper code may also be provided with supporting files such as project and solution files, compilation scripts, dependency and configuration files, documentation and commentary text files to form a Software Developers Kit (SDK).

In an embodiment the method further comprises searching API descriptions from the Internet in response to search parameters received from a user; receiving an API description selection from the user; and receiving a programming language selection from the user.

In an embodiment searching API descriptions includes but is not limited to searching in a local or remote database, or on an API repository or else ware on internet.

In an embodiment the API description is a mark-up language file and the predetermined elements also include one or more of the following: authentication information; request information; response requirements. The request information may enumerate and/or identify the request parameters, for example a request without any parameters may simply request the current temperature of the current location from a weather service, whereas another request may specify different parameters for example times (past or future) as well as different locations for example, units to be used, other information to be returned such as extreme weather alerts and the like. The response requirements may specify how the information is to be returned.

In an embodiment the method further comprises providing a graphical user interface for receiving the Internet address, request parameter and any other API description elements from a user. This may include web forms for inputting the API description.

In an embodiment the method further comprises entering the API description parameters into an instance of a predetermined data structure which defines a superset of potential API descriptions, referred to herein as service description language (SDL). Thus in an embodiment the API description input is converted into another type of API description (SDL instances) which can then be used for interacting with translation code templates for translating the SDL instance into an SDK including API wrapper code.

In an embodiment the method further comprises translating the data structure instance into API source code using a code translation template corresponding to the API source code type selected by the user.

In an embodiment the method further comprises modifying the source code in response to user inputs. This may be accomplished using an integrated development environment (IDE) such as Visual Studio™. The method further comprises compiling the modified source code into an executable file such as an APP for use on a Smartphone.

In an embodiment the method further comprises parsing the received API description into an instance of a predetermined data structure which defines a superset of potential API descriptions. Thus the API description input is converted into another type of API description (SDL instances) which can then be used for interacting with translation code templates for translating the SDL instance into an SDK including API wrapper code.

In a third aspect there is provided a computerised method of generating an SDK for an API of an Internet based service provider, the method comprising: generating a user interface for receiving a description of an API using predetermined elements including an Internet address and request parameter; the user interface having a plurality of web forms with fields corresponding to the predetermined elements; receiving from a user of the interface the description of the API entered at the fields of the web forms in order to generate an API description according to the predetermined elements.

In an embodiment, the method further comprises receiving a programming language selection from the user at the interface. An alternate method is to receive the selection via a widget. The widget process usually initiates from a 3^{rd} party web page.

In an embodiment the predetermined elements also include one or more of the following: authentication information; request information; response requirements. The request information may enumerate and/or identify request parameters, for example a request without any parameters may simply request the current temperature of the current location from a weather service, whereas another request may specify different parameters for example times (past or future) as well as different locations for example, units to be used, other information to be returned such as extreme weather alerts and the like. The response requirements may specify how the information is to be returned.

In an embodiment the method further comprises parsing the received elements into an API description comprising an instance of a predetermined data structure which defines a superset of potential API descriptions. The API description (data structure instances) can then be used for interacting with translation code templates for translating the data structure instance into an SDK including API wrapper code.

In an embodiment the method further comprises translating the data structure instance into API source code using a code translation template corresponding to the API source code type selected by the user.

In another aspect there is provided a translation server operable to translate API description files selected by a user and defining code for interaction with services into software development files defining functions in a software language and readable by an integrated development environment (IDE) selected by a user, wherein translated files read by the IDE present source code to a user for inclusion by the user into a computer program, the source code defining functionality to allow the program to interact with the service, the server including: a user interface operable to receive user data defining selections of an API and an IDE or language; an API file interface operable to receive API description files; a memory template defining a structure for storing API code contained in the API description files, the structure defined by superset of API properties; a set of translation templates operable to define translations from API code stored according to the defined structure to source code presented by the IDE, wherein the source code defines functionality once compiled for interaction with the service, whereby the user can define functionality that allows interaction with services using source code translated by the translation server from any API description having a set of properties within the defined superset.

The embodiments provide a number of advantages. For example any API description file may be supported by the defined superset to be translated into source code in software development files readable by a selected IDE. Additional API description files may be supported merely by addition of properties to the superset to the translation template. Each translation template may support multiple API description files.

There is also provided a first processor operable to read the API description files and populate the memory to store the properties of an API selected by the user whereby the properties of the description file of a selected API is stored in a memory structured according to the defined superset of API properties; whereby the source code translated defines functionality for the program

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are determined to be incorporated herein as if individually set forth.

Embodiments of the SDK generation process can be provided (i) as a cloud service, or (ii) as an on-premise solution, or (iii) as a combination of both (i) and (ii), typically known as a hybrid solution.

In another aspect the present invention provides a computer system operable to generate computer programming code operable to interface with an Application Programming Interface (API), the system comprising:

an API description interface operable to receive API-description code describing one or more endpoints of the API; a template interface operable to receive one or more templates of code defining classes and/or functions in a selected programming language;
a data store operable to use a defined data structure to store records of API description code to provide a structured stored description of the API;
a code generation module operable to combine records of API description code with of code to generate programming code.

The computer system may further comprise a language-selection interface operable to receive data defining a selection of a programming language from a set of programming languages, wherein the code generation module selects units of computer programming code dependent also on the selection of a programming language.

The template interface may be operable to receive templates from two or more candidate templates of two different template sets each candidate template having pointers to the data structure in common and static code in a programming language specific to a respective template set, whereby selection of the templates allows selection of a language for code generated from a common API description.

The computer system may comprise an API selection interface operable to receive data defining a user selection of the API.

The units of programming code may be provided in templates of programming code comprising dynamic code referencing positions within the data structure and comprising static code to be combined with the records.

The data structure may be defined dependent on a set of descriptions of supported APIs.

The data structure may be operable to store a superset of records of API-description code for the set of supported APIs.

The one or more templates may comprise a selected set of templates of code, wherein a set of templates comprises code defining classes and/or functions in a selected programming language.

Further aspects of the invention, which should be considered in all its novel aspects, will become apparent from the following description given by way of example of possible embodiments of the invention.

### BRIEF DESCRIPTION OF THE DRAWINGS

FIG. 1 is a schematic of a user environment in which an APP interacts with a software system via an API;

FIG. 2 illustrates schematically an SDK generation system according to an embodiment;

FIG. 3 illustrates schematically an SDK engine in more detail and according to an embodiment;

FIGS. 4A-4E illustrates a web based API description interface according to an embodiment;

FIG. 4F illustrates a widget used to access a stored API description according to an embodiment;

FIGS. 4G and 4H show additional interfaces used to provide API descriptions to the system;

FIG. 4I shows the information required to use the cloud service for code generation;

FIG. 5a shows a partial API description file;

FIG. 5b shows another example of a partial API description file;

FIG. 6a shows an example table structure for storing the API description;

FIG. 6b shows an overview structure of some of example tables structures;

FIG. 7 illustrates an example SDL according to an embodiment;

FIG. 8A illustrates a C# template according to an embodiment;

FIG. 8B illustrates a Java template according to an embodiment;

FIG. 8C depicts templates showing a set for the PCL language used to generate a C# SDK;

FIG. 9a illustrates schematically transformation of a selected API description into an SDK according to an embodiment;

FIG. 9b illustrates a process flow for generating code from a SDL and provision to the user;

FIG. 10 illustrates an SDK generated according to an embodiment;

FIG. 11 illustrates schematically an SDK generation system according to an embodiment;

FIG. 12 is a schematic of an SDK generation system according to another embodiment;

FIG. 13 is a flow chart illustrating the flow of information in the system of an embodiment;

FIG. 14 illustrates a screen of a user GUI for selecting one of a number of interface processes in an embodiment;

FIGS. 15a-f illustrate various data flows within the system of FIG. 12;

FIG. 16 illustrates is a flow for an SDK generation process of the embodiment of FIG. 12;

FIG. 17 shows a SDK generation service which includes a crawler according to another embodiment.

### DETAILED DESCRIPTION

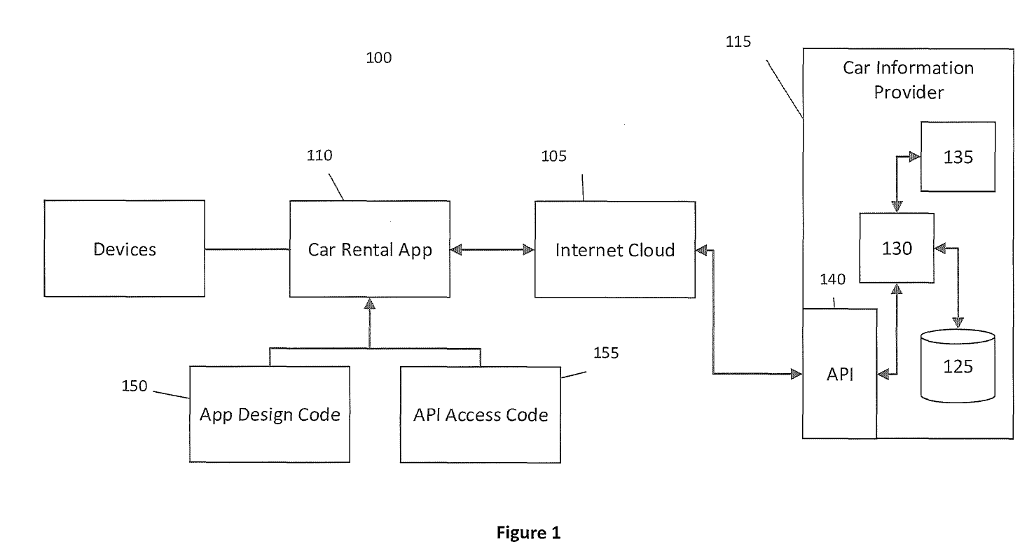

FIG. 1 illustrates an application, or APP, operating environment 100 with a Car Rental APP 105 available in various operating platforms such as Android™, iOS™, or Windows™. The APP 105 interfaces with an internet based software system 115 operated by an internet car information provider in order to obtain a car's information. This interaction is controlled by an API 140, and the communication between the APP 105 and the API 140 takes place over the internet 110. The API provides a service representing the software system 115 as seen by the APP 105. The car information provider may include a processor or controller 130, a database 125 containing the appointment data, as well as other interfaces 135, such as a web interface for a user (not shown). In order to interact with the car information provider 115 via the API 140, the APP 110 sends requests which are recognisable by the car information provider software system 115 to endpoints or resources of the API 140. The APP 105 also receives and recognises responses provided by the car information service provided by the API 140.

The APP 110 shown uses programming code in the form of APP design or business code 150 and API access code 155. The APP design code 150 contains business logic and controls the user interface of the APP. The API access code 155 interfaces with, or controls access to, the API 140.

When software for the system 115 is updated the API 140 may need to be updated. Typical updates to the service might be methods of operation, available requests, and/or the type and format of data available in responses. These updates may require the APP 105 interfacing with the API to be updated and this may typically require an APP developer to alter API access programming code 155 in order to comply with the new API.

The API provider, in this case the car information provider, makes a description of the API available for use by APP developers. The API description is typically a file of code in a mark-up language such as JSON which is readable by a developer and carries information describing the API. For example, it may carry information describing the addresses, resources or endpoints for certain functionality. It may carry information on required formats or syntax for requests and any accompanying data. The APP developer can use the information carried to write appropriate programming code to create an APP including API access code 155 which will interact with the API. The code will typically use classes and/or functions defined in a programming language suitable for a given platform supported by the APP.

When an API 140 is updated, the API provider may make available a modified updated API description for a developer to use to updated the API programming code, such as used in the access code 155 so that the APP 110 can use the updated API 140 to access the service 115.

As the reader will be aware, APPs are often developed using a Software Development Kit which is adapted for a specific programming language and/or platform. Software, development kits typically include programming code written in a specific programming language and platform. The code often includes classes and/or functions which might be used in programming code for an APP being developed or updated.

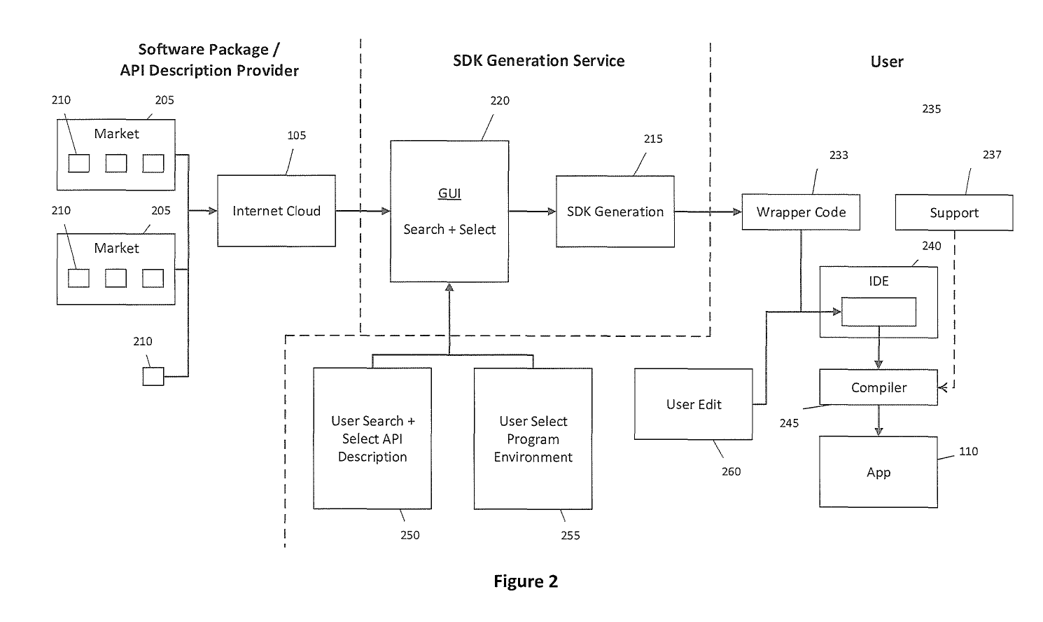

FIG. 2 illustrates a system for generating a software development kit (SDK) which includes programming code for use in APPs to use an API (not shown). An API provider makes an API description 210 available to APP developers. In it's simplest form an API description 210 is code which describes the API in terms of endpoints of the API to send requests to the API and endpoints to receive responses from the API.

API descriptions typically have predetermined elements in code in a mark-up language defining access, such as by Internet addresses. The API description may include elements for endpoints of the API, together with corresponding request and response parameters associated with the each endpoint which describe how an APP needs to interact with API to access functionality of the software system associated with the API. Additional elements may also describe authentication information, such as username and password; request information to modify the request parameter; and response requirements to define the way in which a response to a request is provided. The API description may be made available on Internet based Marketplaces 205, or individually. The elements of an example API description are described in more detail below.

The embodiment of FIG. 2 has an API Interface module 220 which receives API descriptions. The embodiment also has an SDK engine 215 which generates a software development kit (SDK) 235 using the API description 210. The SDK 235 of this embodiment is provided for a specific programming language such as C#, or Objective-C, depending on a selection made, in this embodiment, by the user and received at an interface 255. In this embodiment, data defining user interactions are received at an interface 250 to receive user navigations or searches for an API. These may be at an API marketplace 205 and may involve key-word searches, Once a desired API description 210 is identified, the user selects this together with a desired programming language for the APP, for example Java for iOS or Android.

In some embodiments the data structure provides a way to associate stored API records to relevant templates or sections of templates, or vice versa, to allow code to be generated by combining code in API records with code from templates. In some embodiments this association is with pointers included in the template which point to positions in a data structure that are common to corresponding templates in each template set. This allows a template sets of these embodiments to be used for a generating an SDK from any API supported by the data structure. This also allows SDK code to be generated in any supported language, corresponding to a selection of a template set, for an API supported by the data structure.

The SDK generation engine 215 generates an SDK which provides a kit of programming code in a language selected or corresponding to the programming selected. In this embodiment the kit includes API wrapper code files 233. Depending on the programming language selected, the kit may include support files 235. In this embodiment wrapper code comprises code in a programming language readable by a developer and which can be compiled into machine code required for the API access code 155 for an APP. The support files 235 of various embodiments may comprise a compiler, a build instructions file, a call library, a README file and other files as would be appreciated by those skilled in the art. The wrapper code file 233 of this embodiment may be viewed and modified in an Integrated Development Environment (IDE) such as Visual Studio™ by Microsoft™. This allows a user such as an APP developer to review the kit of programming code and modify (260) it as desired. The user may then compile the viewed/modified wrapper code file 233 into API access code 155 for an APP 110 using a suitable compiler 245, if the relevant programming language is compiled, In this embodiment compiler support files compiler are included with the SDK support files 235 if appropriate.

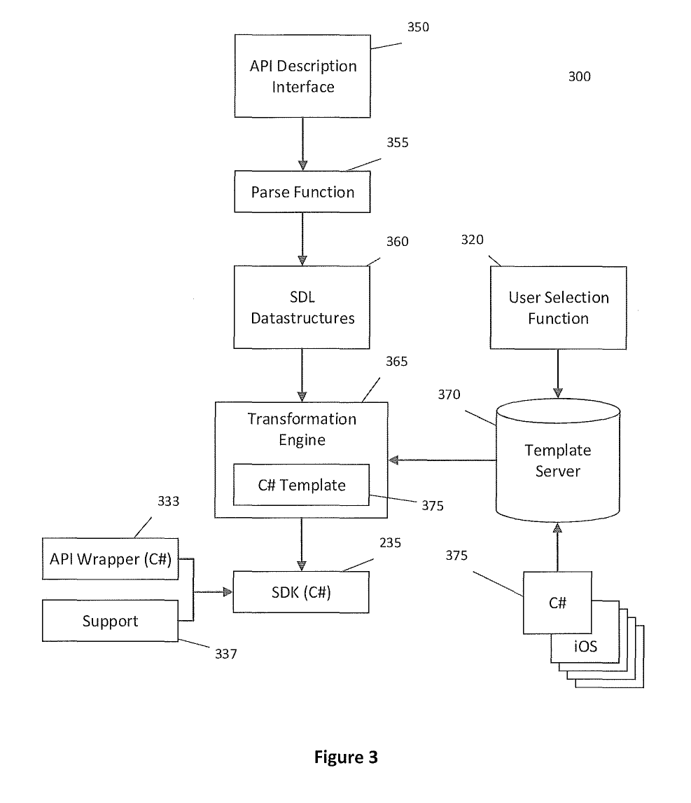

FIG. 3 shows a more schematic of an SDK code generating system according to another embodiment. In this embodiment, an SDK engine 300 comprises an API description interface 350 which receives data or code carrying information provided by a user to describe an API. A parse module 355 parses the API description provided by a user into elements of a data structure used by a data store 360. An SDK generation engine 365 generates SDK code using templates from a template server 370 containing a number of templates 375 and selected by programming language by a selection module 320.

The API description interface 350 of this embodiment provides a mechanism for receiving code or data carrying information describing an API. In this embodiment the API description interface 350 performs receives API descriptions in different ways and different formats, typically as elements of code or data corresponding to endpoints, and parameters of an API. In this embodiment code elements are defined in a mark-up language. This specific embodiment supports three processes of receiving API descriptions is supported. In one process, a number of predetermined code elements describing an API may be received at the interface 350. In a second process a file containing code in a mark-up language is imported. For example a JSON file with describing the API, using predefined code elements, is imported. The interface 350 is adapted to identify similar predetermined elements in a number of formats. In another example, an imported XML file comprises the same API description elements as the JSON file but in a different format or syntax. In various embodiments API descriptions may be imported in other predetermined formats, and the interface 350 may provide a search facility for identifying a desired API description from an API market place for example. In a third process, a description of an API format may be received at the interface 350. The interface 350 of this embodiment provides a web Graphical User Interface GUI to receive user selections of API description elements or to directly receive code entered by a user to describe an API.

The parse module 355 identifies and converts the API description into a data structure which is capable of describing a number of supported APIs. In this embodiment the data structure is object oriented. Each API description is stored as a set of API records in an instance of the data structure 360. The data structure of this embodiment is arranged to allow API records to be associated with templates and even sections within templates. In this embodiment the association is made by pointers for predefined parts of the data structure stored in given templates.

In this embodiment a user of the system 300 is able to select the language for the SDK for the API. In this embodiment the selection is made by selection from a number of sets of templates 375, where each set is associated with a language, such as C#, Java or Objective C. Sets of templates 375 for languages supported are stored in a template server 370 and the selected templates are provided to the transformation engine 365 which populates this with generic format data from the appropriate data structure instance into API wrapper code 333 in a given programming language, such as C#, and development support files 337 which together form a software developers kit (SDK) for the selected language (e.g. C#). In this embodiment a set of templates correspond to a common language or platform and include code for each place in the data structure. Therefore the engine 365 can combine any record stored for a supported API with a suitable template selected a set of templates corresponding to a selected language.

Embodiments of the system 300 may be used with search and select aspects of embodiments described below in order to streamline APP development and update processes.

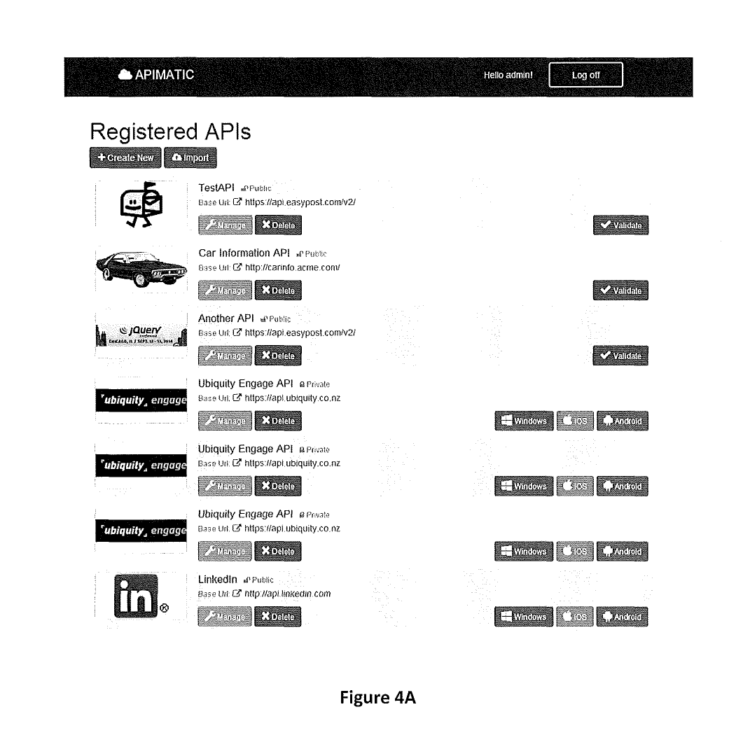

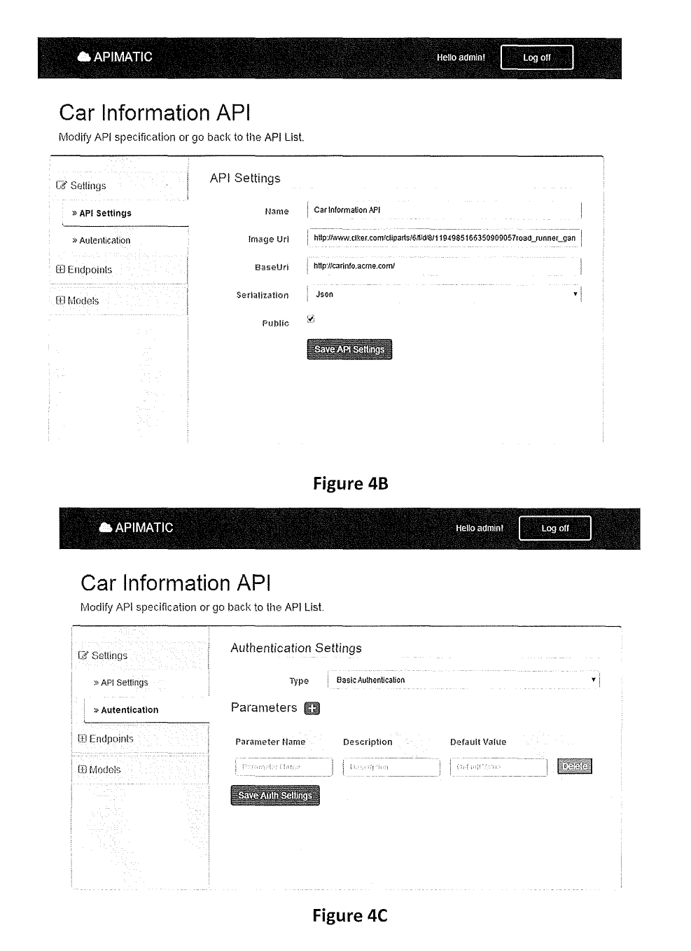

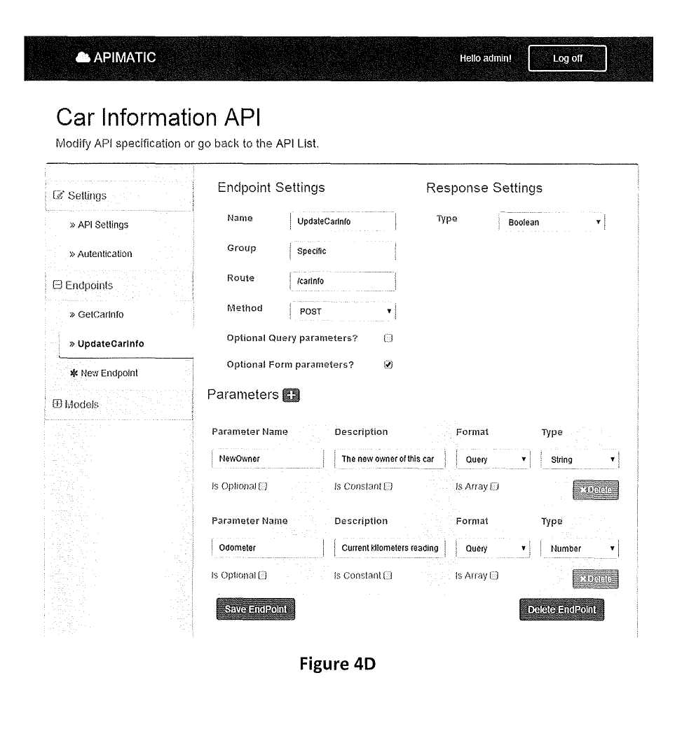

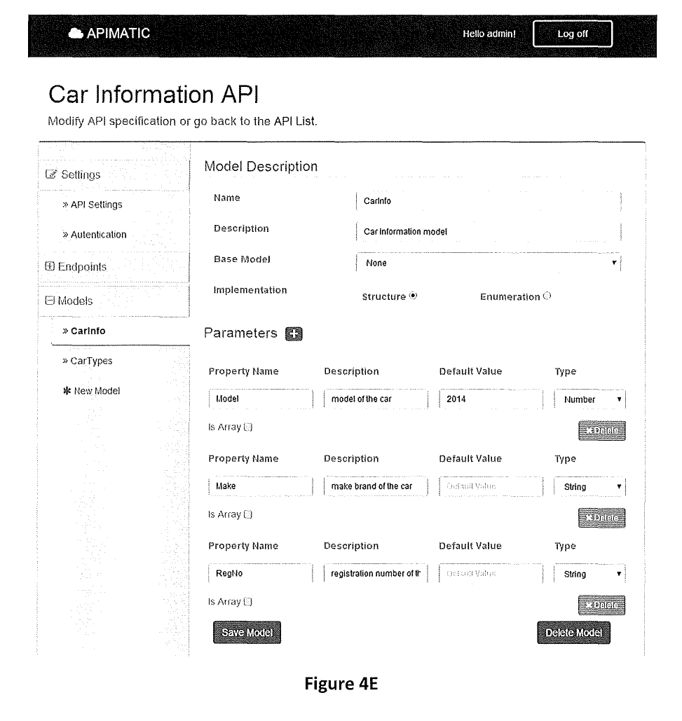

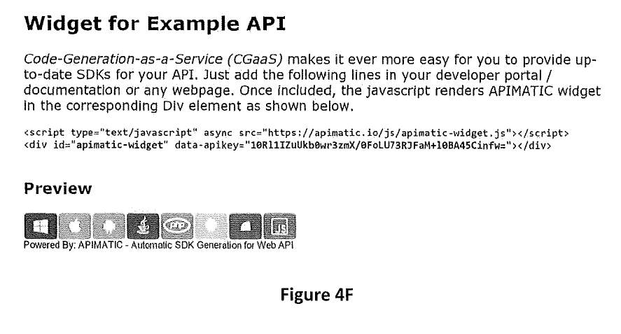

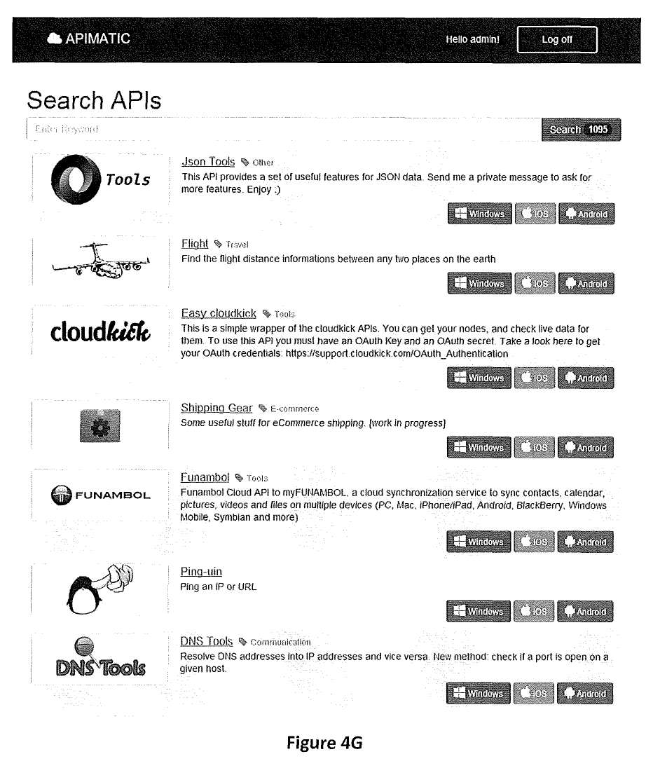

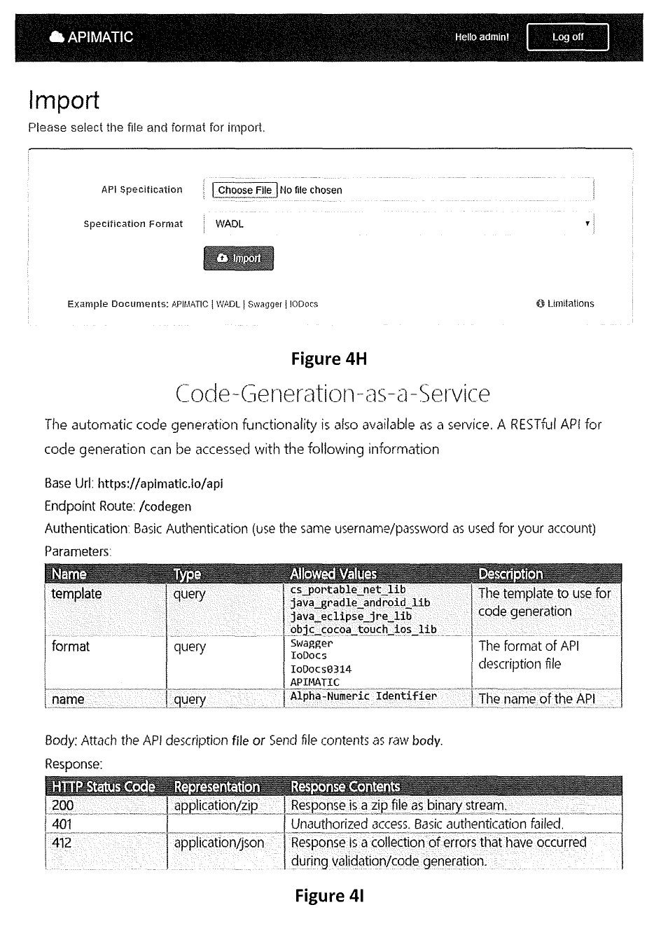

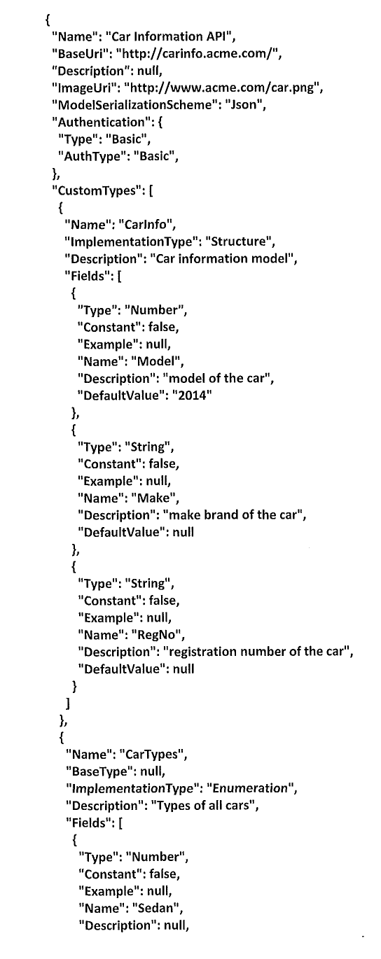

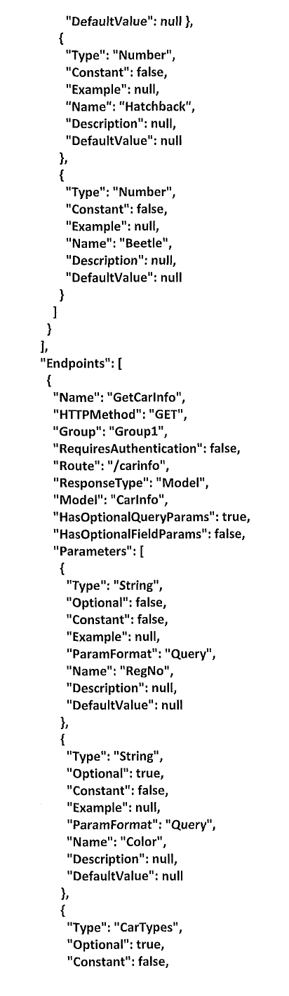

FIGS. 4A-4F illustrate one embodiment of an SDK generation system of an API description interface based on a description of an API using received using web based forms which a user completes in order to input the API description. The web based forms may be completed by an SDK user or an API consumer in order to enter a new API description or update an existing API description. The existing description to be updated may be stored by the SDK generation system. Once the appropriate forms are completed, the parsing function 335 transforms the modified API description into new or updated instance of the SDL data structure 360 so that the API description is in a format suitable for use by an API consumer wishing to retrieve an SDK in a selected programming language.

A user interface of a SDK generation system of an embodiment is described with reference to FIG. 4A to FIG. 4I.

FIG. 4A shows a number of API descriptions as they might appear for selection at a user interface for an administrator. A user, such as an API description provider may create their own API description, selecting “Create New”, or may update an existing API description stored by the system by selecting “manage”. When a new API is described or an existing API is modified, a “Validate” button appears in-front of that API, as shown in the figure. When that button is clicked, the API description is validated against a set of rules (not shown). In this embodiment 50 or more rules are used. If an API description is valid, the “Validate” button is replaced by a set of buttons each corresponding to a language or platform supported by an SDK generation system. Selection and clicking of a button initiates generate and downloading of a SDK generated in the selected language.

FIG. 4B illustrates an “API” settings form of user interface of an SDK generation system. The user interface receives inputs allowing a user to specific settings for the “car information” API of FIG. 4A towards describing the API. The form of FIG. 4B allows a user to specify an API name, an image url, a base url, a serialisation and whether the API is public.

FIG. 4C illustrates an “authentication” settings form which receives inputs from a user ability to enter one or more additional parameters which may be specific to the API description and which relate to authentication. The form of FIG. 4C allows a user to specify an authentication type parameters names, parameter descriptions, and default values.

FIG. 4D illustrates an “endpoint” settings form of a user interface which allows settings to be specified for one end point of the car information API. In this embodiment an Endpoint corresponds to a defined resource or API function, and comprises an Internet address. The Endpoint shown corresponds to a resource which updates car information to enable a downstream APP to add or post data to the car information software package with which the APP will be interacting. Their Internet addresses may be respectively www.CarInformationAPI.com/GetCarInfo and www.CarInformationAPI.com/UpdateCarInfo, these addresses being resolvable into numerical Internet addresses as will be appreciated by the reader. The form shown in FIG. 4 allows the addition of parameters which may be specific to the car information software package, such as new owner information, and odometer reading. The format or type of this parameter can be controlled as shown.

As noted previously, user interaction at a user interface exemplified by the forms of Figures A to D must be completed in a pre-determined manner. In this embodiment fields of the forms receive elements which describe an API.

Various other elements of an API description may be defined at the user interface including request parameters, additional request information, response parameters such as what data is required or a response model, name and so on as will be described in more detail below. Typical request parameters will correspond to GET, PUT, POST, DELETE, and PATCH methods of the API. These may be supported by additional request information where required, for example POST (new data) include the data to add and PUT (modified data) includes the how the existing data is to be modified. However, the GET method may require no additional information and instead simply requests whatever data is current stored at the Endpoint.

A response parameter or response model is illustrated in FIG. 4E and specifies the data to be returned from the Endpoint. In the example shown, model, make and registration number information pertaining to a car can be retrieved by an APP utilising this Endpoint. In the embodiment, the form enables the structuring of information output by the software package using “models” which allow the way in which data is presented to be controlled as shown in FIG. 4E. Once the API description has been fully defined by an appropriate set of web-based forms, the data captured may then be transformed into corresponding SDL data structures 360 as described in more detail below.

By providing a user interface with forms, API description data can be collected in a pre-defined way.

FIG. 4F shows a widget which provides embodiments with an alternative process for generating and download SDKs. The widget may be placed at a web site, typically an API developers' portal, with the help of JavaScript and HTML code to display controls to allow selection of a language or platform and to initiate a process that uses a data-key to retrieve an API description from an API database structured or schemed using a data structure defined to support a set of APIs. FIG. 4F shows an example data-key “data-apikey”, or may be some other id specific to the API, from database. Once the API description is loaded in memory, the SDK generation process continues.

FIG. 4G depicts an interface which receives inputs from a user to search of navigate for APIs from a set of publically available APIs to select their API descriptions. This allows API descriptions of APIs listed at API Marketplaces and API exchanges for general use to be selected for use by the SDK generation system. Using the interface of FIG. 4G a user can search for an API, and can generate an SDK in the desired programming language without having to describe it. Once the API is selected the SDK generation system retrieves a corresponding API description from a server provided at the API marketplace. The SDK generation system then parses the description into records in an, instantiated data structure and generates an SDK using the description and templates.

FIG. 4H illustrates an alternative interface which allows a user to input a selected API description. The interface allows the user to import a complete description of an API as a data file . Files supported by this embodiment WADL, Swagger, ioDocs, and a customized format “APIMatic” introduced to import an API description.

FIG. 4I illustrates an API which allows an SDK generation service, it self, of an embodiment of the invention to be accessed as a cloud service. A RESTFUL API for code generation can be accessed with the information shown in FIG. 4I. The process may be initiated at a 3rd party's server when a user sends the API description and code generation parameters as a service request. The server receives the request and generates the corresponding SDK. The user is given the generated SDK or a link to download the generated SDK in response.

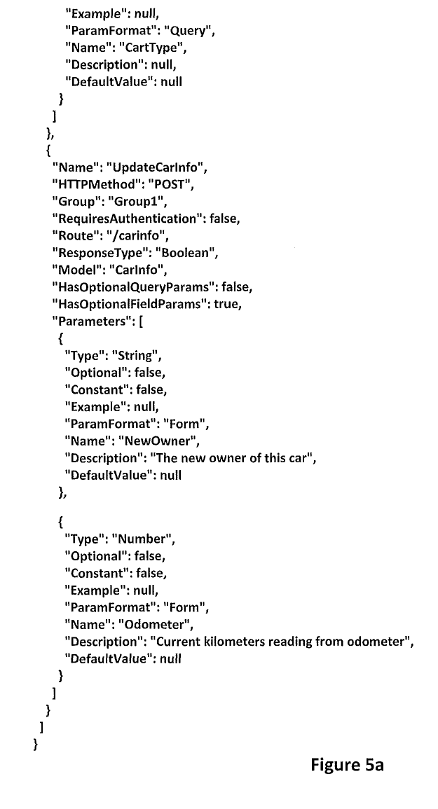

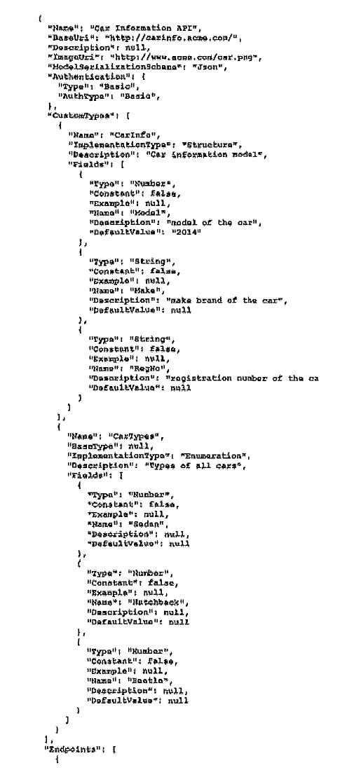

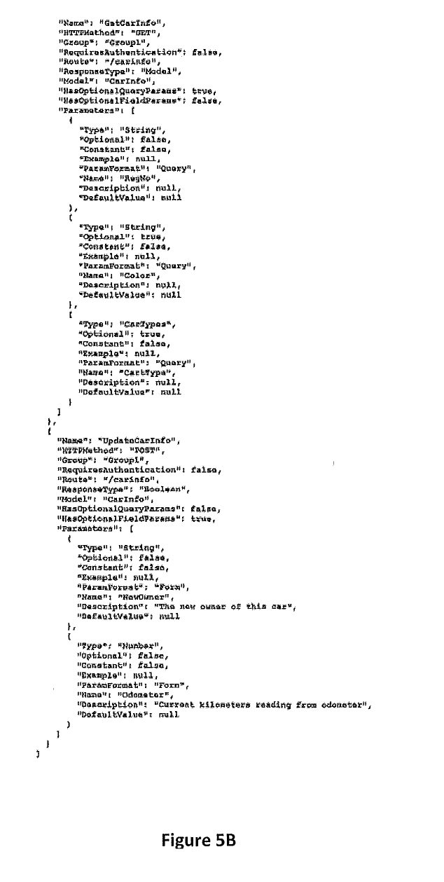

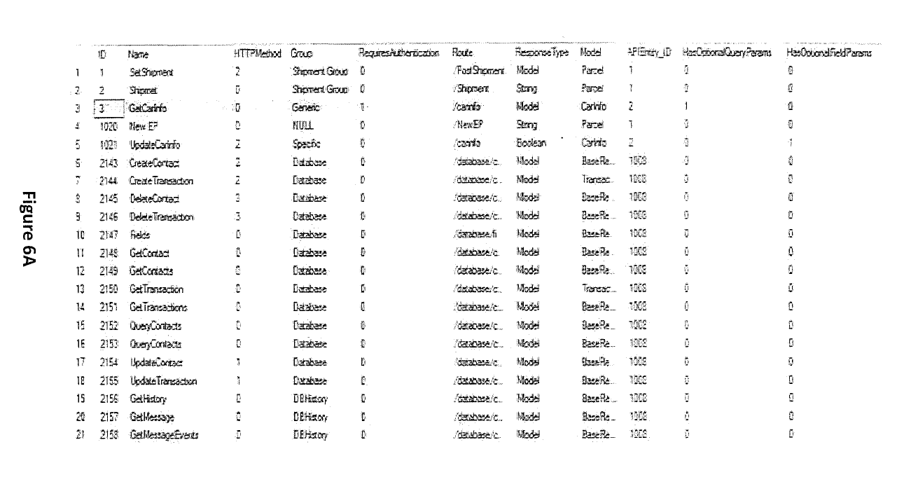

FIGS. 5a and 5b illustrate a specification equivalent of an API description that can be imported into an embodiment of the system as illustrated in FIG. 4H. The code shown corresponds to API descriptor options or elements such as Internet address and request parameter, and represents only a portion of the full file required to fully describe the API. The file shown in FIGS. 5a and 5B is JSON as shown.

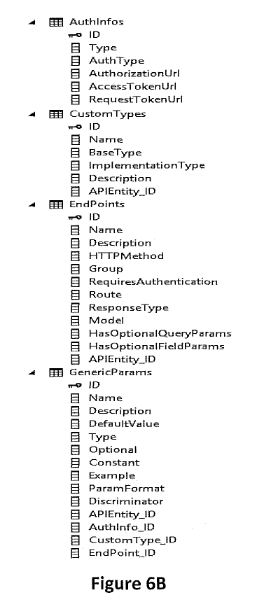

FIG. 6b shows the structure of exemplary tables used initially by an embodiment of the invention to store API descriptions entered at the forms of FIGS. 4A-4F or the processes of 4G-4I.

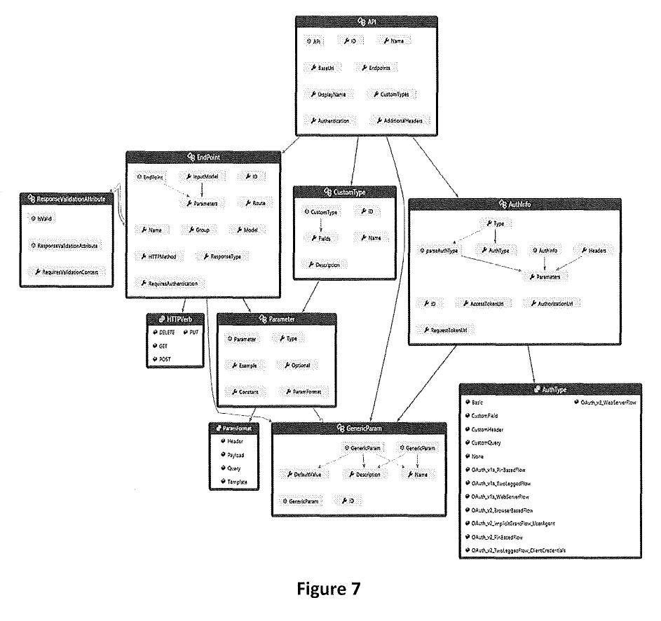

FIG. 7 illustrates an object oriented data structure used by a data store (not shown) to store API description received as code and/or data received at API description interfaces. The API descriptions are stored after being parsed by a parsing module. The data store may be recognised by the reader as an instantiation of a data store. Also, the stored records describing the API may be recognised by the reader to be an intermediate or service description language (SDL). The data-structure in this embodiment defines records for a superset of elements of APIs supported by an SDK generation system. A particular instance corresponding to a received API description will typically include a sub-set of the records defined by the data-structure. As can be seen, the API description may be stored in object oriented form and having a convenient arrangement of sub-structures connecting the various settings, endpoints and other parameters. The API description stored using data structure form can be used with a number of sets of templates to generate SDK code corresponding programming language as described below. In this case a set of templates each corresponds to a common language and different sets of templates correspond to differed programming languages. In this case also, a set of templates is required to be combined with code or data from possible each stored record of an API description.

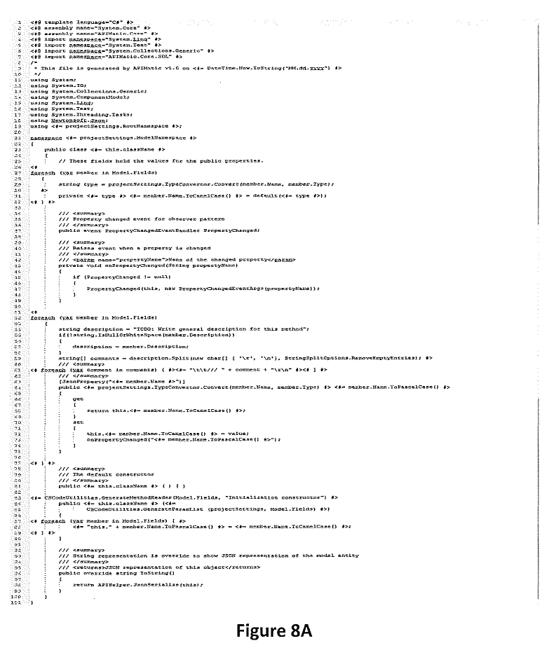

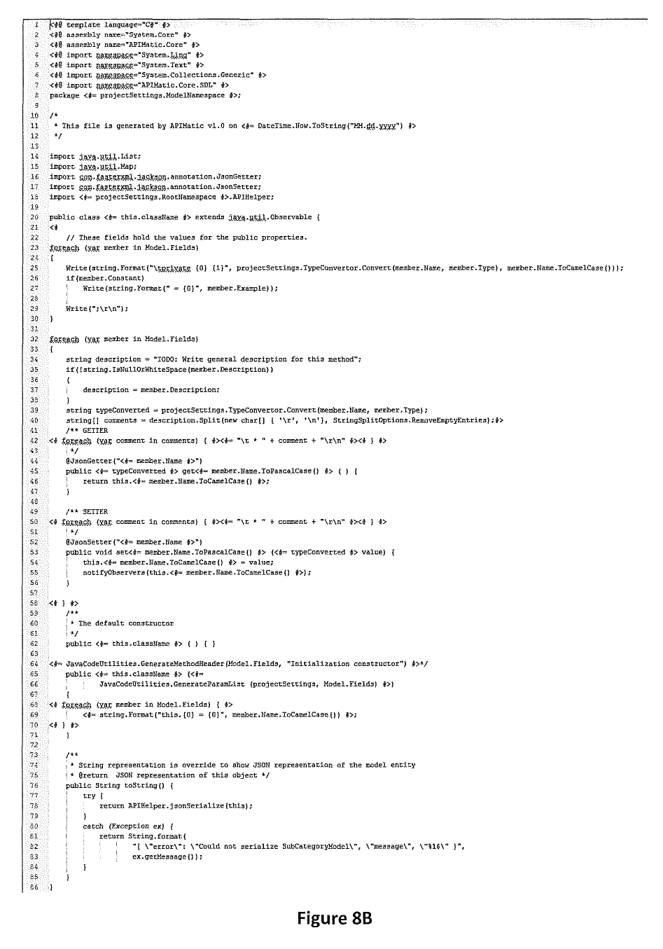

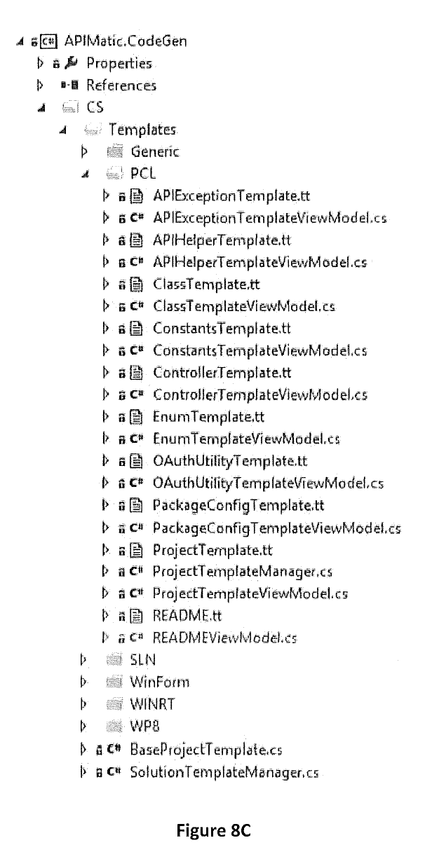

FIG. 8A illustrates a C# template. A corresponding template from a JAVA template set is shown in FIG. 8B. These and other programming language templates are stored in the template server 370 grouped into a set of templates for each language and/or platform. Each of the number of templates can be used with an API description stored using the same data structure. The templates used to generate a C# PCL (portable class library) SDK are shown in FIG. 8C. Typically each template comprises lines of code including SDL data structure pointers, the pointers indicating a corresponding location of data in the data structure which is to replace the pointer. In this way code in the templates is completed with code from appropriate records stored in the API description in order to generate the various SDK files. Typically also, each template from a programming language selection is associated with a particular substructure of the SDL data structure, and retrieves data from this location, however other embodiments may have other arrangements known to the reader.

FIG. 8c illustrates a template set for the C# language, containing a set of templates such as: APIExceptionTemplate.tt, APIExceptionTemplateViewModel.cs, APIHelperTemplate.tt, APIHelperTemplateViewModel.cs, ClassTemplate.tt, ConstantsTemplateModel.tt, ConstantsTemplateViewModel.cs, ControllerTemplateModel.tt, ControllerTemplateViewModel.cs, EnumTemplateModel.tt, EnumTemplateViewModel.cs, OAuthorityTemplateModel.tt, OAuthorityTemplateViewModel.cs, PackageConfigTemplateModel.tt, PackageConfigTemplateViewModel.cs, ProjectTemplateModel.tt, ProjectTemplateViewModel.cs, ProjectTemplateManager.tt, READMEV.tt, READMEViewModel.cs. Also illustrated are templates for BaseProjectTemplate.cs, and SolutionTemplateManager.cs. Also illustrated are files containing template sets for other programming languages. The titles of these templates are exemplary.

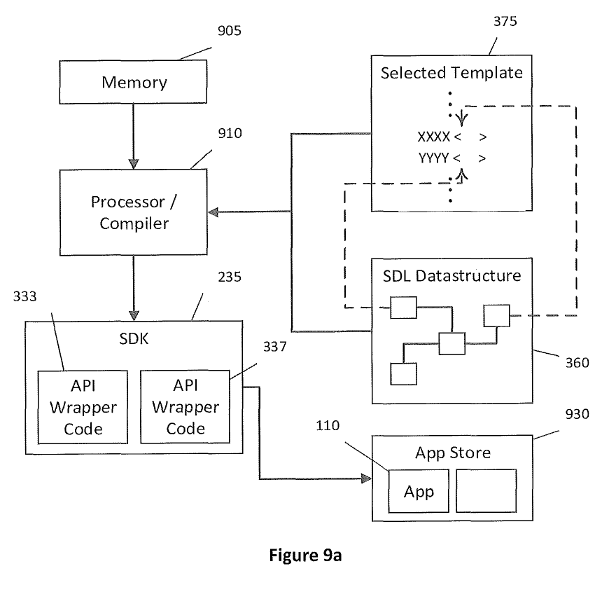

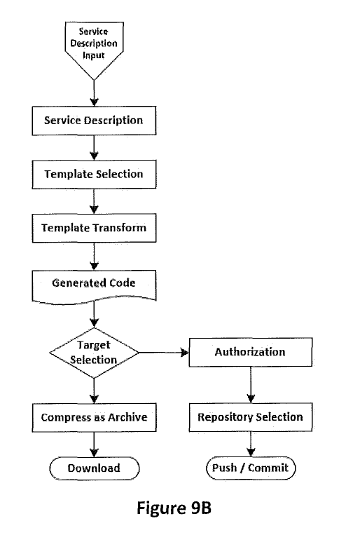

FIG. 9a illustrates a system for generating programming code dependent on an API description stored using a defined data structure and dependent on a suitably selected template. SDK code in a selected programming language is generated by combining code from selected templates with API records describing a given API stored in an instance of a data structure. The templates in the embodiment illustrated comprise static code to be included in the SDK and also includes dynamic code referencing code in API records stored using the data structure to combine with the static code. In this embodiment combining the template code with records of a stored API is achieved by filling in spaces defined in the template with records which are accessed by pointers in a template to within the data structure.

The SDK engine of the embodiment of FIG. 9a comprises a memory 905 and a processor 910. The memory 905 may comprise any suitable volatile and non-volatile memory including RAM, hard disk drive (HDD), Flash memory or any other suitable memory structure. These may be used to store the web forms of FIGS. 4A-4E, the received JSON file of FIG. 5, the API descriptor tables of FIG. 6, the SDL data structures of FIG. 7, as well as instructions to implement the various functions of the SDK engine such as the parse function 355 and the API description interface 350. The processor 910 may be configured by instructions in the memory 905 to perform a code translation function using the data structure for a selected API description and a selected programming template as shown. The selected data structure corresponding to a registered API description may be stored locally or on a separate server for example.

Similarly, a number of programming templates may be stored locally or on a remote server 370. The processor 910 executing as a compiler generates an SDK 235 which comprises API code 335 in the programming language of the selected template. The SDK may also comprise support files 337 depending on which programming template is selected.

FIG. 9b shows the process flow for generating SDK from the SDL data structure according to an embodiment. The process starts at S9-1 when an API description for a service is input when a user selects an API description and requests SDK generation in one of the supported platforms or programming languages. In a service description step, S9-2, the description of a selected API is fetched from a database and loaded into memory. At a template selection step, S9-3, templates required to generate an SDK for the selected platform are selected from a store of available templates, and loaded into memory. At a generate code step, S9-4, a template transform step, the process renders a stored API description according to the selected template. The contents of the template can be characterised as static and dynamic blocks of code, where static blocks are not changed, and dynamic blocks reference code loaded from the instance of a data structure storing a description of the selected API into the dynamic blocks to generate the SDK code. For example, the loop shown at line 52 of FIG. 8a (template to generate C# Code), will be executed for each record in the instance of data structure to generate code comprised of API records and template code. The code generated using different templates is gathered as a package, referred to herein as an SDK. User instructions in support files to compile the generated code are also added to the SDK, In the target selection step S9-5, upon successful generation of an SDK, a user is asked to select a target to store the generated SDK. In the compress as archives step S9-6, if selected by a user, the SDK is compressed into a single file and a download link is forwarded to the user at step S9-7. After an authorisation step S9-8, a repository selection step S9-9, optionally chosen by a user, the SDK is stored in a selected online repository which may involve user authorisation at S9-8 for accessing.

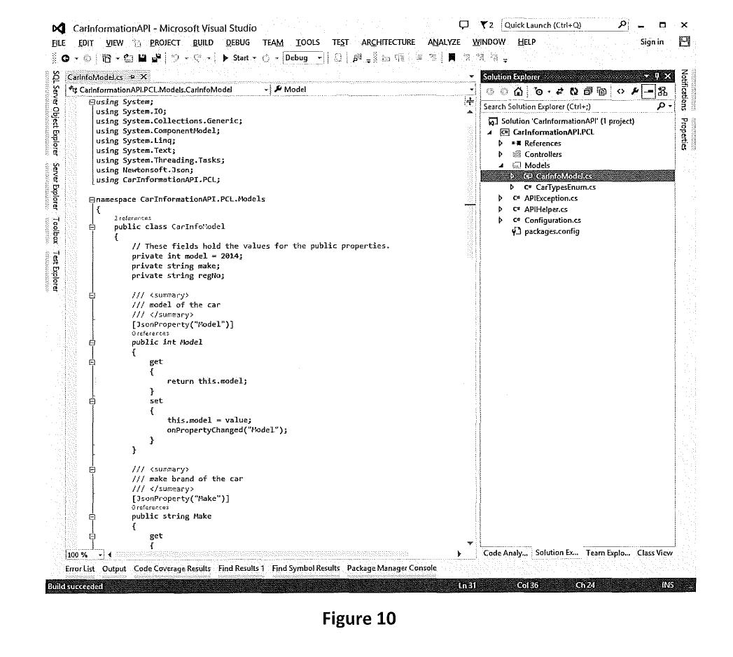

FIG. 10 illustrates an SDK generated according to an embodiment for the C# programming language in which generated SDK code files 333, containing programming code, are generated and where various support files 337 are included to assist with compiling the generated code into a binary code file.

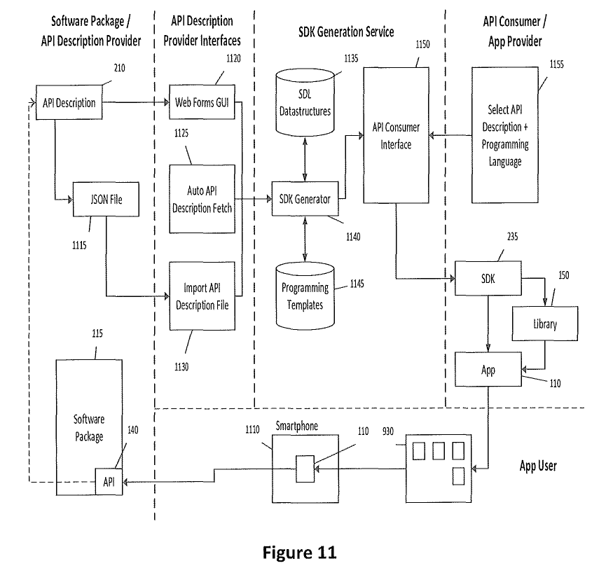

FIG. 11 illustrates the distribution of functionality and data for implementing an SDK generation system according to an embodiment. The various components of this system can be used by or allocated into different domains of use as shown, and including: the software package and API description provider; API description provider interfaces; SDK generation servers: API consumer and APP provider; APP user. As previously described with respect to FIGS. 1 and 2, the software package provider such as a calendar service or a car information service provides a software package 1115 containing data and which allows interaction with user devices such as SMARTPHONES 1110. Interaction with users is performed by an API 1140 which interacts directly with an APP 105 installed and operating on a SMARTPHONE.

The API has a corresponding API description 210 which is usually written as a specification in human and computer readable file such as a JSON file 1115. When the software package provider updates the API 140, or provides a new API, the corresponding API description 210 is updated or provided for the first time. The API description provider then interacts with one or a number of API description provider interfaces available within the system. For example as described with respect to FIGS. 4, the API description provider may enter the API description using a web forms based GUI 1120. Alternatively, a corresponding machine readable file 1115 may be imported by a suitable interface 1130. In a further embodiment, an automatic API description fetch function 1125 is also implemented to automatically fetch a JSON file or equivalent machine readable file if a user selects the API from an API marketplace/directory. The various API description provider interfaces 1120, 1125, 1130 may be implemented using a webserver or other hardware as would be appreciated by those skilled in the art.

The received API description, comprising various pre-determined code elements with associated data if appropriate, are provided to an SDK generator 1140 in an SDK generation service domain of the system. In this embodiment the service is implemented on a separate server, or implemented on the same server as the API description provider interfaces for example. The SDK generator 1140 is coupled to an SDL data structures database or server 1135 and a programming templates database or server 1145. The SDL server 1135 stores a number of instances of data structures corresponding different API descriptions. The programming templates server 1145 stores a number of sets of templates, each set corresponding to a respective programming language such as C# and JAVA. The SDK generator 1140 is also coupled to an API user interface 1150 for developers who are anticipated consumers of APIs. In some embodiments the user interface is implemented as a web interface for use by an APP developer or provider. The APP provider or API consumer interacts with the interface 1150 by selecting an API together with a programming language in which an SDK for that the corresponding API description is required.

The selection data 1155 is input into the API consumer interface 1150 to enable the SDK generator to select the appropriate instance of the data structure from the server 1135. The generator also selects a template set from the template server 1145 as appropriate for the selection of programming language. API records stored in the instance of the data structure and templates from the appropriate are combined by the generator 1140 to generate an SDK 235 which is provided to the API consumer. In this embodiment the SDK 235 comprises API wrapper code in the selected programming language for the selected API description. Using the SDK 235, the APP provider is able to generate an APP 105 which may be made available at an APP user via a separate APP store 930, for example.

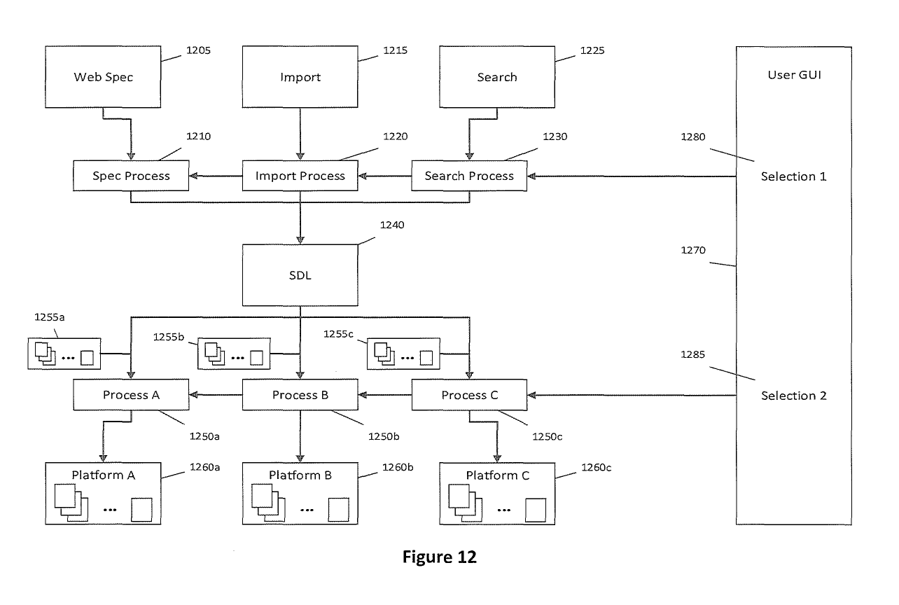

An alternative embodiment SDK generation system is shown in FIG. 12. In this embodiment a user of the system is able to select from one of a number of API description input, or interface, processes for API descriptions in different formats. The user is able to select from a number of platforms or programming languages in which to generate the SDK. The system may receive API description elements using a web specification GUI 1205, which has an associated specification process 1210 in order to convert the received API description into an SDL data structure instance 1240. Alternatively an API description may be imported 1215 in one of many file formats such as JSON, XML or other suitable formats. An associated input process 1220 converts the received API description elements into a corresponding SDL data structure. In a further alternative, the user may input navigation or search data into search engine 1225 to identify and select a desired API description from an API description market place or other repository. An associated search process 1235 receives selected API description elements and parses these for storage into an instance of a data structure, such as the SDL described herein. The selected API description may be provided in one of a number of different file formats which can be imported and converted as appropriate.

In one embodiment the data structure instance may be agnostic to API description file format so that all API description elements will have the same format within the data structure irrespective of the file type in which they were received. The selection data 1280 may carry a selection of a file format such as JSON or XML in addition to a selection of the API description interface process 1205, 1215, 1225.

The user also provides a second selection 1285 in order to determine which platform or programming language for the SDK generated. For example platform A may correspond to C#, platform B may correspond to JAVA, and platform C may correspond to IOS. Each platform type has an associated process 1250a, 1250b, 1250c, which retrieves corresponding template files 1255a, 1255b, and 1255c. These template files are then populated with records from the selected API description as stored in the corresponding instance of the data structure 1240 to generate corresponding SDK files 1260a, 1260b, 1260c. The SDK files of this embodiment include API wrapper code.

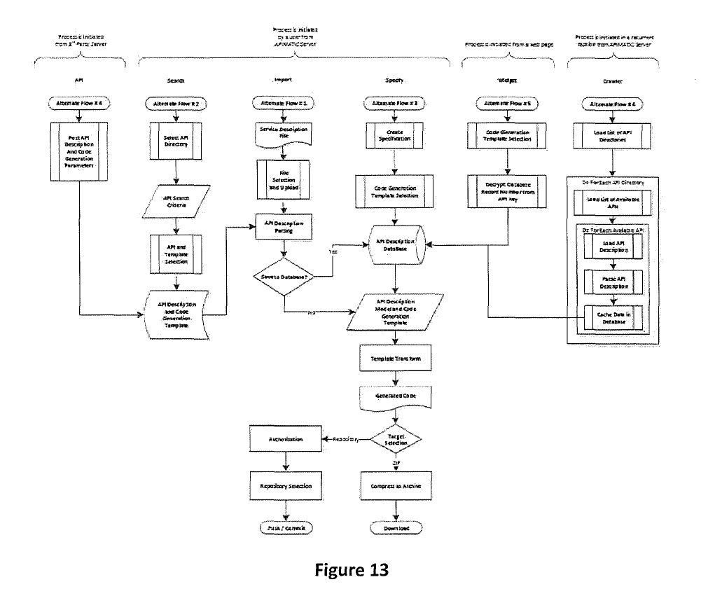

FIG. 13 is a flow chart illustrating a process for generating programming code from an API according to another embodiment of the present invention. Illustrated are six sub-processes for a user to control with the system. These are imported by user S13-1, Search S13-2, Specify S13-3, API from 3^{rd} party server S13-4, Widget S13-5 and Crawler S13-6. In this embodiment, Imported, Search and Specify are initiated by a user from a server. The Widget process is initiated at a webpage, the API from 3^{rd} party server process is obviously initiated from a 3^{rd} party server, and the Crawler process starts at a server associated with this system in a recurrent fashion. FIG. 13 illustrates the flow of data in each sub-process S13-1 to S13-6, from beginning till the downloading/publishing of an SDK.

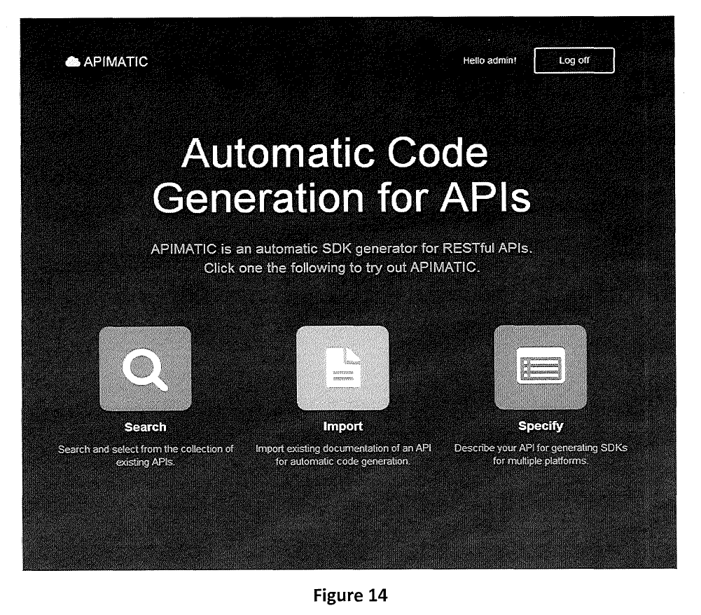

FIG. 14 is a screen shot of a user interface GUI showing the first three interface options—search; import; specify.

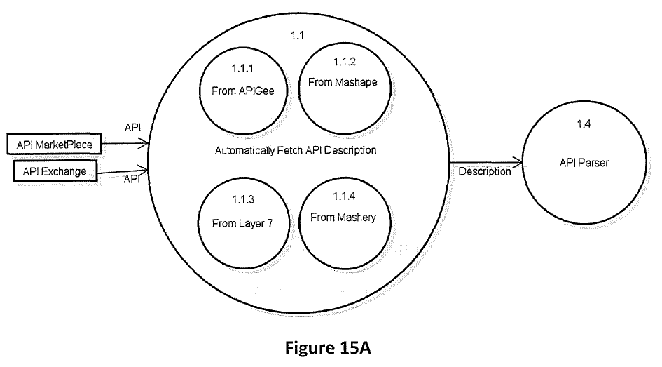

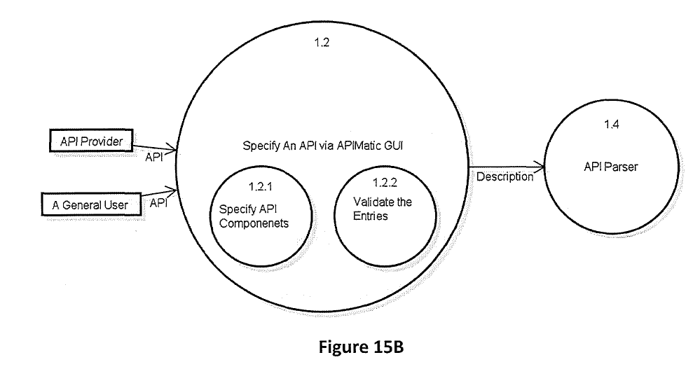

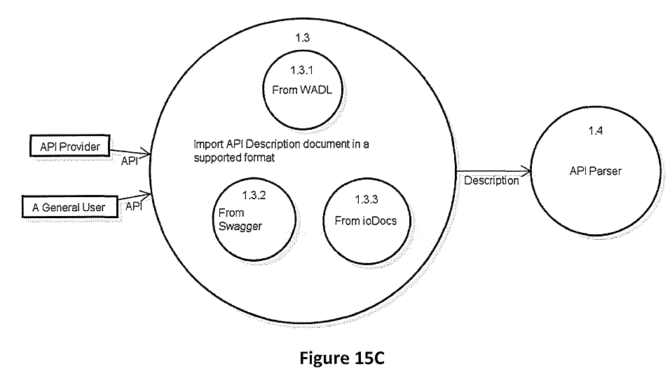

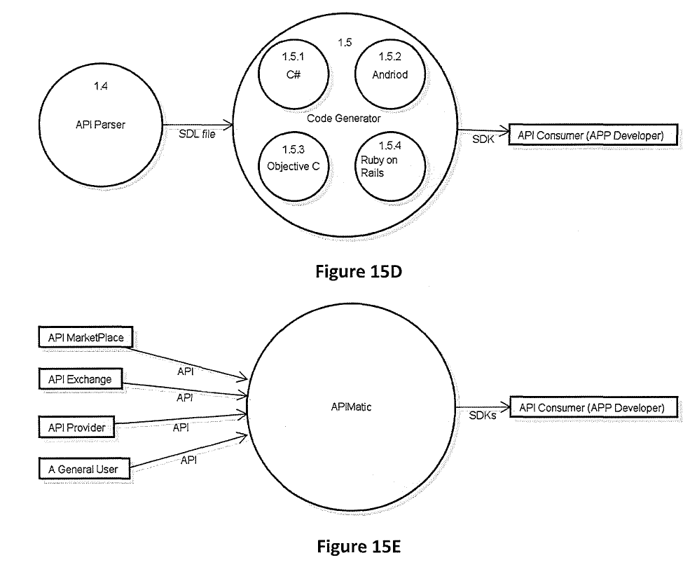

FIG. 15a illustrates a process and system 2000 according to an embodiment of the present invention. The process fetches an API description in one of a number of known formats (eg WADL) from an API market place 2001 or API exchange 2002. Four example marketplaces are illustrated as 2011, 2012, 2013, and 2014. The API description will then be parsed by an API parser 2115 corresponding to one of those formats (eg WADL). This process may be initiated in response to an API search on the market place and upon which selection of a particular search result automatically fetches the selected API description to the system for parsing.

FIG. 15B illustrates a process 2200 corresponding to specifying an API description which may be available from an API provider 2201 or general user 2202. A user enters the data into a GUI 2203 in order to specify the API description elements 2205 and to validate elements 2206.

FIG. 15C illustrates a process and system 2300 in which an API description 2301 is imported in a specific format from API provider 2302 or other source 2303, in SWAGGER 2304 for example. The description is then input to an API parser 2305.

FIG. 15D illustrates the code generation process and system 2400 in which an instance of a data structure is converted into SDK files by a code generator 2301 corresponding to a selected programming environment or platform such as C# (language) 2302, Android (platform) 2303, Objective C (language) 2304 and Ruby on rails (language) 2305.

FIG. 15E illustrates a process and system 2500 for the generation of SDKs from a number of sources from which API descriptions may be retrieved for conversion into SDK. The sources shown are APM market place 2501 API exchange 2502, API provider 2503, and a general user 2504. API descriptions by these are received by the SDK generation system 2505 outputs a generated SDK to a developer 2506.

FIG. 15F illustrates a process for SDK generation from a range of sources. API descriptions from sources shown as API marketplace 2601 and API Exchange 2602 are automatically fetched by process 2603. API descriptions from API providers 2603 and general users 2604 are received 2605 as user specifications input at a user interface. API descriptions from API providers 2603 and general users 2604 are optionally also imported 2508 as a document or file in a supported format. Once fetched, received or imported the API descriptions are parsed 2609 for storage using a defined data structure 2610, for data storage standardised for a set of supported APIs and the code generation process 2612 for generating SDK files for use by an APP developer or the like.

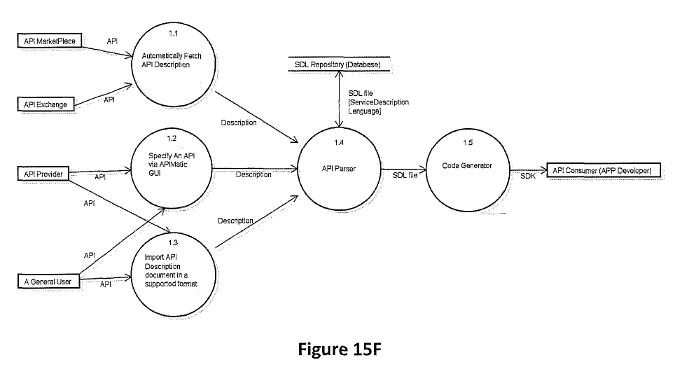

FIG. 16 illustrates a code generation process S16 for converting a data structure instance into SDK files. The process S16 receives a selection by a user of a platform such as C# at step S16-1, and imports the corresponding set of (C#) template files at S 16-2. For each template file at loop point S16-3, each line of code is parsed at step S 16-4, and when an pointer in the template to within the data structure, or SDL in this embodiment, is identified, a record storing code from the API description is inserted in place of the pointer. The process according to this embodiment generates programming code by combining code in the template with code stored as records in the data structure to generate programming code for an SDK. The process then moves at step S16-6 to the next template file in the set. This process is completed for each template file and the completed template files are output as the SDK.

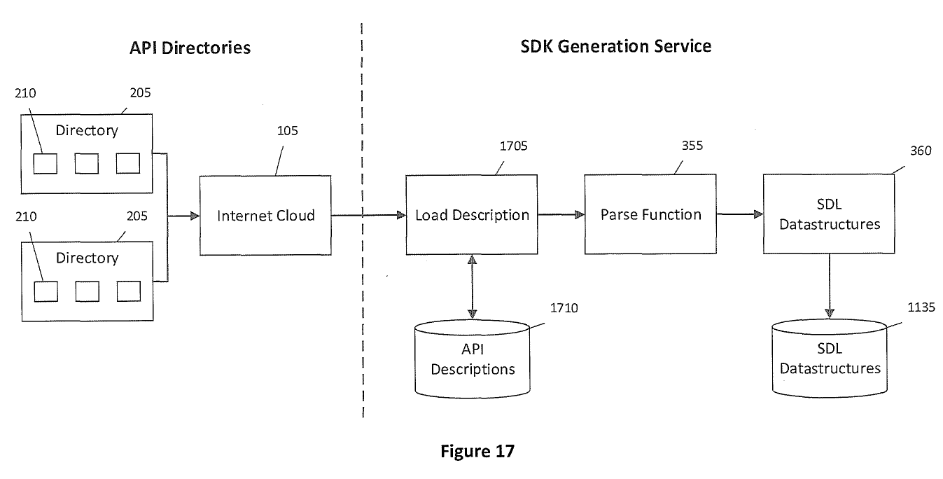

FIG. 17 illustrates the operation of the Crawler in its ability to crawl existing API Directories 205 for a list of API Descriptions 210 to automatically generate SDKs for and list on a public searchable location. These directories may be crawled through either APIs provided by the directories themselves, or through the act of web scraping when no such API is available. In addition to API description files themselves that are retrieved from the directories, associated information is also gathered such as the API's name, description and potentially an image for the API.

When the Crawler receives an API Description it attempts to Load the API Description 1705 to check whether the API Description is a new to the SDK generation system or an update to an existing API description already in the database. To check this it communicates with an API Description Storage 1710 and compares hashes of files to determine whether or not it has changed.

If an API has been found requiring parsing and storage (ie. New or Updated) it proceeds to the API Parser 355 which generates an SDL Data structure 360 and is then stored inside the SDL Data structure storage 1135 for further searching and/or SDK generation on demand through other processes such as those outlined in FIG. 2, 11 or 12.

This process is then repeated for each API Definition found, and for each API Directory known about.

A process for receiving an API description into the SDK generation system according to an embodiment of the present embodiments is illustrated in FIG. 17.

The A list of API Directories is maintained which provide access to API Descriptions in a variety of formats (Swagger, I/O Docs, Google Discovery, etc.). These directories are a few key competitors in the API marketplace such as Mashape, Mashery, Apigee and APIs.IO. Further sources used are sites such as GitHub which contains many thousands of API Definitions that can easily be searched for and accessed through their Search UI.

After each API has been added from each API Directory the APIs are made available for search, modification and download in all available languages by users. Further updates to these existing APIs are supplied as new versions, as opposed to completely new API entries, and are made available as soon as they are found.

An embodiment of the invention using a widget to select an API will now be described. As used to describe this embodiment a widget is a name of a combination of a javascript and a corresponding html snippet. The html snippet is embedded in a document (webpage, or other html enabled documents), which invokes the javascript with some parameters. A visual representation is displayed by the widget in the embedding document, which consists of some UI elements such as buttons, hyper-reference links and formatted text for information.

Interaction with the UI element invokes the javascript to call an API on a server associated, SDK generating server, with an SDK generation system, on-cloud or on-premises. The system then initiates SDK code generation. The result of the code generation is returned back to the user in the form of a file.

In this embodiment each API description stored on an SDK generating server (on-cloud or on-premises) bears a unique id. This id is used by the server using an algorithm to create a unique token named API KEY, which can be used to locate the corresponding stored API description. One method used by an embodiment to create the API KEY is through use of cipher algorithms. A method used by another embodiment is to store a generated token against an API description. A Token used, rather than simply a unique identifier, is in this embodiment to prevent third parties guessing the id, which is a systematic easy-to-guess number, and then use it to generate code from other's API descriptions.

An example API key and a code generation template are given below:

(A) apimatic_1101--ENCRYPT->hatywofnHAOIbhfywedka*vbs6=

### (B) 1234-1231-1235235-12--STORE AGAINST->apimatic_1101

The API KEY and CODE GEN TEMPLATE, are the two parameters required by an API for a SDK generation service. A Code Gen API, which is running as a service on the APIMatic server. The API KEY is embedded in the html snippet, whereas the CODE GEN TEMPLATE is selected as a result of user's interaction with the visual UI elements.

A process according to an embodiment of the widget operation is as follows.
1. An Html snippet is embedded in a webpage.
2. This webpage, when loaded in a browser, renders visual UI elements.
3. A user interacts with the visual UI elements, such as through a click or pressing of a key.
4. Javascript programmatically loads an API KEY from the html snippet.
5. Javascript programmatically loads CODE GEN TEMPLATE from user's interaction with the visual elements.
6. Javascript invokes an API on the APIMATIC server, sending the two parameters with the request.
7. APIMATIC server invokes code generation from the give inputs as following.
7.A If the APIKEY is an encrypted token, API description is located by decrypting the APIKEY and loading the API description through its unique ID.
7.B If the APIKEY is a store token, the API description is located by matching the given APIKEY against the stored tokens.
8. The server associated with the SDK system loads the SDL data of API description and invokes code generation against the user selected template.
9. Generated code is packaged in a file and sent back to the Javascript caller.
10. Javascript receives the response from the APIMATIC server and provides it to the user in a file format.

Further and additional embodiments will now be described.

In some embodiments a generated SDK includes wrapper code as well as project, solution, configuration and/or support components or libraries, and program code capable of interpretation or compilation. In the context of APIs, SDKs are also known as client libraries, API wrappers and helper libraries.

Embodiments of the invention comprising the SDK generation processes described herein are provided (i) as a cloud service, or (ii) as an on-premise solution or (iii) as a combination of both (i) and (ii), which the reader may understand as a hybrid solution.

In embodiments of the present invention interfaces and models of the system described herein may be co-located or co-hosted or distributed between different locations, hosts and servers depending on requirements of the specific embodiment.

In embodiments of the present invention steps in processes described herein may be co-located or co-hosted or distributed between different locations, hosts and servers depending on requirements of the specific embodiment.

In alternative embodiments the selection of the programming language and/or template-sets may be made automatically by the system based on data or codes associated with an APP or IDE, or similar available data.

In some embodiments support files are also generated by an SDK engine to accompany the programming code defining classes for example. In embodiments, the support files may support compilation if appropriate for the programming language selected or may include scripts if appropriate. The support files may define access to additional code or libraries to be used by an API interface.

In some embodiments inputs at user interfaces are received to select a programming language. In other embodiments the inputs are used to select a platform and the programming language is inferred from the selection of the platform. Some embodiments receive data or code which identifies a language platform for automatic selection.

Embodiments of the present invention have a repository, data base or other storage to stored API descriptions for a number of APIs using a data structure.

Embodiments of the invention system provides enhanced user convenience for developing API interface code with user friendly interface which is flexible yet comprehensive. Embodiments of the invention provide a system which is system is highly scalable, with additional interface types being allowed and additional API description formats being supported by a writing of an appropriate input process. Similarly embodiments allow additional platforms to be supported by the writing of a corresponding SDK template sets.

In embodiments of the invention various functionality, code and data described may be distributed on respective servers or on any combination of servers as might be appropriate. For example the API description provider interfaces and SDK generation services functions may all be provided on a server owned and operated by the software package provider, and for use by an API consumer. Alternatively, an automated SDK provider may provide the API description provider interfaces and SDK generation service on a server or servers owned and operated by this intermediary and for use by both the API consumer and the API description provider. As a further alternative, the services may be provided as part of the APP store 930 offering, and installed on their servers.

In embodiments of the invention code is operable to interact with an API by defining operations for an application to interact with an API using defined communication protocols and services.

Embodiments of the present invention provide a process or system which generates a Software Development Kit including classes and/or functions for interfacing with an API. Embodiments include classes and/or functions corresponding to functionality required to interface with an API description to allow the native classes to be used in programming code for applications, or other computer programmes using a service associated to an API. In some embodiments the classes and/or functions may be native classes generated dependent of API descriptions.

Embodiments include native classes and/or native functions corresponding to functionality described in an API description to allow the native classes to be used in programming code for applications, or other computer programmes using a service associated to an API, to import functionality from the API or associated service into the SDK or programming code for an APP, for example.

In some embodiments template code is combined with records stored using a data structure to describe an API. In some embodiments this combining is achieved by filling in spaces defined in the template. In other embodiments sections of static code may be may be concatenated with code from API records. In further embodiments the API records may be data used to select or define code. In some embodiments sections of static code may be concatenated with code from API records. In further embodiments the API records may be data used to select, point to or define code. In some embodiments two or more template sets may have templates with pointers to the same parts or a data structure, or the same records stored in instances of the data structure, but have static code in different programming languages so that any API supported and storable by the data structure can combined with programming code in a programming language selected by a selection of the template set.

The SDK generation engine 215 generates a kit of programming code in the language selected. In this embodiment the kit includes API wrapper code files 233 and, depending on the selected programming language, support files 235. In some embodiments wrapper code comprises person readable code which can be compiled into the machine code required for the API access code 155 for an APP. The support files 235 of various embodiments may comprise a compiler, a build instructions file, a call library, a README file and other files as would be appreciated by those skilled in the art. The wrapper code file 233 of this embodiment may be viewed and modified in an Integrated Development Environment (IDE) such as Visual Studio™ by Microsoft™. This allows a user such as an APP developer to review the kit of programming code and modify (260) it as desired. The user may then compile the viewed/modified wrapper code file 233 into API access code 155 for an APP 110 using a suitable compiler 245, if the relevant programming language is compiled, In this embodiment compiler support files compiler are included with the SDK support files 235 if appropriate.

Embodiments of the present invention comprise process equivalents, which will be apparent to the reader, for the systems described herein with reference to the Figures.

Embodiments of the present invention comprise system or apparatus equivalents, which will be apparent to the reader, for the processes described herein with reference to the Figures.

Embodiments of the present invention generate programming code, programming code, other code which is in a language which conforms to a language readable by developers and which specifies functionality for an APP, application or computer programme.

Embodiments of the present invention have a selection interface to receive data defining user selections of an API and/or receive data defining user defined properties of an API and/or receive data defining a selection of a programming language and/or platform for an APP and/or receive data defining a search or navigations for an API at a marketplace for example.

Embodiments of the invention provide a control for users of systems for machine generation of programming code.

Embodiments of the present invention provide a system which allows APIs to be added to a set of supported APIs independently of templates for additional languages and platforms and vice versa.

In some embodiments of the present invention programming code or programming code is generated as part of a SDK generated. In some embodiments the code generated includes generated wrapper code.

Embodiments of the present invention may use an alternative identifier to the data-key of FIG. 4F, which may be another id specific to the API.

Embodiments of the present invention provide a method or system for generating programming code which provide native classes and/or native functions for endpoints, resources, parameters, methods, and various metadata of APIs.

Embodiments of the present invention provide generated code for use by developers use in place of manually writing code specific to an API to update the programming code. This may provide advantages to the development cycle of APPs, particularly where the APP supports multiple programming languages for a number of platforms.

Embodiments of the present invention provide generated code for use by developers use in place of manually writing code specific to an API to update the programming code. This may provide advantages to the development cycle of APPs, particularly where APIs are updated frequently.

Embodiments of the present invention provide generated code for use by developers use in place of manually writing code specific to an API to update the programming code. This may provide advantages to the development cycle of APPs, particularly where a population of developers have varying levels of knowledge of programming for APIs and/or varying approaches to programming.

Embodiments of the present invention provide generated code for use by developers use in place of manually writing code specific to an API to update the programming code. This may provide advantages to the development cycle of APPs, particularly where standardisation of programming code for APPs using APIs is required.

Embodiments of the present invention may generate SDKs or programming code in languages known to the reader to not require compilation for use in an APP.

In some embodiments an instance of a data structure used to store API descriptions may be a data base.

In some embodiments of the invention data structures used to store descriptions of APIs may be a service description language (SDL).

Embodiments an SDK engine, such as shown in FIG. 3 for example, provide an automated mechanism for generating a SDK in a programming language of choice for an API of choice. These embodiments allow each set of templates, corresponding to a language or platform, to be used for any supported API. This enables existing APPS to be updated quickly when the API description changes. This is may be particularly advantageous when the APP is supported in multiple programming languages.

Embodiments of the invention, such as shown in FIG. 3 for example, provide a system for SDK generation that is scalable. New API descriptions can be supported by updating or adding functions performed by a parse module, such as 355. In some embodiments this may be independent of other parts of the system. A description of a newly supported API can be stored using a data structure capable of describing a number of supported APIs. The data structure can be used with templates to generate SDK files in a language or for a platform that can be selected for and from a user to select one of a plurality of platforms or programming language environments into which to generate corresponding SDK files. In some embodiments the data structure can be used to select a template from a set of templates for a given language or platform. In some embodiments the data structure can be used to associate or combine predefined elements of an API description with a suitable template which provides programming code to interface with the aspect of the API described by that element, such as a given endpoint. Embodiments allow a new platform or programming environment to be added to the system 300 by writing appropriate template files. In some embodiments this may be done independently of other parts of the system.

Embodiments of the invention comprise a computer system configured to provide the systems and/or perform the processes described herein.

Embodiments of the present invention comprise an API interface code server for API interface code suitable to be combined in an Integrated Development Environment (IDE) with business code entered by a user of the IDE, wherein the interface code defines functionality for application to interface with a selected API. The server of some embodiments may provide code which is also specific to the IDE or a programming language used with the IDE. The user of the IDE may import code from the server to develop or update an API interface for an application. An API interface of some embodiments may be updated to interface with an updated API or alternative API. An API interface of some embodiments may be updated so as to allow the API interface to be compiled or be interpreted on an updated or alternative platform or programming language.

Embodiments of the invention comprise programming and/or executable code operable to perform any of the processes or provide the systems described and illustrated with reference to the drawings, or operable to configure a computer, processor or similar device or network of these to perform the processes or provide the systems described and illustrated with reference to the drawings. Embodiments of the invention comprise a computer having a processor, working memory and programme memory operable when executed to perform any of the processes or provide the systems described and illustrated with reference to the drawings, or operable to configure a computer, processor or similar device or network of these to perform the processes or provide the systems described and illustrated with reference to the drawings.

Various embodiment are in the form of programming and/or executable code stored on any suitable storage medium known to the reader and stored in any suitable format or protocol known to the reader and including magnetic, optical, flash and cloud storage mediums.

The reader will appreciate that code ‘operable’ to perform a given functionality includes code which is operable after interpretation, compilation or other treatment known to the reader and using resources known to the reader such as build files, build scripts and compilers or platforms.

Where in the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope of the invention as set out in the claims.

1. A computer implemented process for generating programming code operable to interact with an API, the process comprising the steps of:
receiving API description code describing the API;
storing the API description code in an instance of a data structure to provide stored API records describing the API, wherein the data structure is capable of describing any API from a set of supported APIs from which the API may be selected;
loading one or more templates of program code from a stored set of templates, wherein a set comprises code in a programming language selected from a set of supported programming languages and wherein selection of a template set determines the programming language of generated code; and
retrieving API records and combining them with code in retrieved templates of a selected template set to generate program code in the programming language of the template set.

2. The computer implemented process of claim 1 comprising generating a user interface operable to receive inputs identifying, describing or selecting an API or a file describing the API.

3. The computer implemented process of claim 1 comprising generating a user interface operable to receive inputs identifying, describing or selecting a template set or programming language.

4. The computer implemented process of claim 1 wherein the data structure is common to each template set.

5. The computer implemented process of claim 1 to wherein the data structure is common to each API supported.

6. The computer implemented process of claim 1 wherein the process is performed by a software system which provides an API which is operable to receive descriptions of APIs and to provide generated SDKs.

7. The computer implemented process of claim 1 wherein combining the templates with API records may comprise filling in the template with the API records.

8. The computer implemented process of claim 7 wherein combining comprises filling in spaces defined in the template for API records.

9. The computer implemented process of claim 1 wherein Individual templates are retrieved dependent on the data structure, or specific records in an instance of the data structure.

10. The computer implemented process of claim 1 wherein the API records stored using the storage structure may be associated with templates by the storage structure.

11. The computer implemented process of claim 1 wherein the API description comprises a description of endpoints of the API and input and output parameters associated with the endpoints.

12. The computer implemented process of claim 1 wherein the templates comprise code defining methods and/or classes and/or functions in the programming language.

13. (canceled)

14. (canceled)

15. (canceled)

16. A computer system for generating program code in a selected programming language operable to interact with an API, the system comprising:
a structured storage for API records which describe an API, the storage structured so as to be capable of describing one or more supported APIs from which the given API may be selected;
two or more template-sets each set comprising templates of program code to be filled in with relevant API description to generate code, wherein the templates of a common template-set comprises code in a common programming language selected from a set of supported programming languages;
an API interface operable to receive API description code describing endpoints of the API and describing input and output parameters associated with the endpoints to describe conditions for interaction with the API, the API interface operable to populate records of the structured storage to provide a stored description of the API;
a language selection interface operable to receive inputs to identify a selection of a supported programming language or supported platform for an application which interacts with the API; and
a kit generation engine operable to generate code dependent on the template-sets and dependent on the API description code received.

17. The computer system of claim 16 wherein the API description code is received in a file containing a structured API description.

18. The computer system of claim 16 wherein the API description code may be received as inputs at a user interface to allow a user to define code describing an API.

19. The computer system of claim 16 wherein a kit comprises a collection of classes or types in a programming language, wherein the classes or types define functionality to interact with an API.

20. The computer system of claim 16 wherein a kit comprises compiler files to allow code generated classes to be compiled.

21. The computer system of any one of claim 16 wherein a kit provides API access code or API interface code for a program or web application or a mobile application.

22. The computer system of any one of claims 16 wherein a template comprises stored programming code.

23. The computer system of any one of claims 16 wherein spaces for API records are defined in code stored in the template.

24.-50. (canceled)
